(19) United States
(12) Patent Application Publication
(10) Pub. No.: US 2011/0119102 A1
(43) Pub. Date: May 19, 2011

(54) Paperless Docketing Workflow System

(75) Inventors: Monroe Horn, Franklin, MA (US); Rory Apperson, Danielson, CT (US)

(73) Assignee: SUNSTEIN KANN MURPHY & TIMBERS LLP, Boston, MA (US)

(21) Appl. No.: 12/948,696

(22) Filed: Nov. 17, 2010

Related U.S. Application Data
(60) Provisional application No. 61/262,048, filed on Nov. 17, 2009.

(51) Int. Cl. G06Q 10/00; G06F 15/16; G06F 17/00

(52) U.S. Cl. 705/7.13; 709/206; 715/273

(57) ABSTRACT

A workflow system provides role-specific console programs that display information for working attorneys, covering attorneys, paralegals and others. The system enables a working attorney's workflow items to be covered by another attorney, without intermingling display of “to do” items belonging to the covering attorney with “to do” items belonging to the working attorney. Another aspect of the system enables automatically attaching documents that are relevant to a workflow item to an e-mail message.

### CROSS REFERENCE TO RELATED APPLICATIONS

This application claims the benefit of U.S. Provisional Patent Application No. 61/262,048, filed Nov. 17, 2009, titled “Paperless Docketing Workflow System,” the entire contents of which are hereby incorporated by reference herein, for all purposes.

### TECHNICAL FIELD

The present invention relates to office workflow systems and, more particularly, to workflow systems that facilitate instantaneous attachment to an email of documents pertinent to a workflow item and that distinguish between workers who are assigned responsibilities for completing stages of workflow items and workers who are responsible for temporarily covering for assigned workers, while the assigned workers are unable to access the workflow system.

### BACKGROUND ART

Workflow systems are computer-based systems that keep track of items of work that are to be performed by people. For example, in a bank or other lending institution, a loan request may be sequentially processed by a series of functional departments before the loan is finally made or refused. One functional department may review a loan application for completeness; a subsequent functional department may obtain the applicant's credit report; and yet a subsequent functional department along the workflow may check the applicant's residential address or housing history and compare this information to information in the application and in the credit report. Each application may be represented by a workflow item stored in the workflow system. The workflow item may include associated electronic documents, some of which may be scanned copies of paper documents that initiated the workflow item (such as the original paper loan application) and others of which may be generated at various stages of the workflow.

Continuing the previous example, as each departmental function is performed with respect to a given loan application, the status of the corresponding workflow item is updated to reflect what department now has responsibility for processing the application, i.e. the current “stage” of the workflow item. Workflow systems may be used by the functional departments to identify which loan application to process next. In addition, workflow systems may be used by management to keep track of backlogs in various departments and the status (stage) of a given workflow item.

In many contexts where conventional workflow systems are used, each function may be performed by any person within an associated functional department. For example, any clerk in a department that obtains credit reports may obtain a credit report for a particular loan applicant, and any loan officer in a bank may approve a loan. In a sense, workers within each functional department are interchangeable. This arrangement minimizes overall latency time for the workflow items, inasmuch as a workflow item need not wait in a queue until a particular clerk or a particular loan officer becomes available. Thus, known workflow systems assign groups of people to each function (stage), and any of the people in the functional department may process any workflow item.

Some prior art workflow systems support “watch lists” and “supervisors” who have read-only access to workflows and workflow items. Thus, a supervisor may view the status (stage) of workflow items on the supervisor's watch list. However, through the workflow system, the supervisor can not complete a workflow item. Known prior art workflow systems store “to do” items in undifferentiated lists. Thus, if a workflow item were assigned to two attorneys, the workflow item would appear in both attorneys' “to do” lists, which would be confusing, inasmuch as it would not be clear which attorney has primary responsibility for completing the stage of the workflow item. Thus, one of the attorneys may inadvertently perform substantive work on an item that is the responsibility of the other attorney. In a worse scenario, both attorneys would perform the work, because an undistinguishable “to do” item appears in both their “to do” lists.

Many packaged workflow systems are available from vendors, such as Appian Corporation, Reston, Va. 20190 and Pegasystems, Inc., Cambridge, Mass. 02142. In addition, toolkits for building customized workflow system are available from vendors, such as Metastorm, Baltimore, Md. 21202.

Law firms and some other businesses have unautomated workflows for processing correspondence from clients, courts, patent offices, foreign associates, vendors and the like, as well as workflows for processing outgoing correspondence, preparing patent applications, etc. Most such businesses do not use computerized workflow systems, because existing workflow systems do not meet the needs of these businesses. An exemplary workflow in a law firm involves receiving correspondence that includes: an Office Action from a patent office in relation to a client's patent application; docketing receipt of the Office Action and an associated due date by which a response must be filed with the patent office; and generating and sending a letter to the client to report the Office Action.

Most law firms assign responsibility for each stage of completing a workflow item to a particular person, rather than to a functional department. For example, a particular “working attorney” is typically assigned to each patent application (or sometimes to each client), and that attorney is responsible for reviewing incoming correspondence related to the patent application (or to the client), for sending reporting letters to the client and for completing any legal work necessitated by the incoming correspondence. Each attorney may be responsible for one or more patent applications (or one or more clients). Similarly, each patent application (or client) may be assigned a particular paralegal who handles other stages of the workflow, such as docketing due dates.

When a working attorney is absent, such as during a vacation or illness, another attorney may be assigned to “cover” for the working attorney. The covering attorney may not be responsible for performing the working attorney's substantive work; however, the covering attorney may be responsible for checking incoming correspondence to ascertain if any of it is urgent or if any of it would not otherwise be handled in a timely manner, given the absence of the working attorney. In general, the covering attorney ensures no deadlines are missed, but typically does not perform substantive work on behalf of the working attorney. That is, the covering attorney typically performs substantive work only if the working attorney is absent and will not return, or is unlikely to return, in time to timely handle the work.

### SUMMARY OF THE INVENTION

An embodiment of the present invention provides a computer-implemented method for storing information about at least one workflow item. For each such workflow item, information identifying a person (an “assigned person”) is stored in a computer database in association with information about the workflow item. An example of an “assigned person” is a “working attorney.” The assigned person has a responsibility to complete the workflow item. According to the method, a capability for storing in the computer database information identifying a person (a “covering person”), in association with the information about the workflow item, is also provided. The covering person has responsibility for the workflow item while the assigned person is unavailable to complete the workflow item. An example of a covering person is a covering attorney. In some cases, the at least one workflow item may include at least one communication from a patent office.

Optionally, a presence datastore may be accessed to determine if the assigned person is available. The presence datastore may be used to automatically identify the covering person. The capability for storing information identifying the covering person may be used to automatically store information identifying the covering person. The presence datastore may be used to automatically identify the covering person based on a classification of the workflow item.

Another embodiment of the present invention provides a computer-implemented method for generating workflow items. The method includes automatically checking for delivery of an e-mail message to at least one predetermined e-mail address. If such a message is delivered, a workflow item is automatically created, based at least in part on a source address of an e-mail message delivered to the at least one predetermined e-mail address. In some cases, the e-mail message to the at least one predetermined e-mail address may be an e-mail message from a patent office.

Automatically creating the workflow item may include automatically creating the workflow item based at least in part on a rule base that identifies which portion of the delivered e-mail message is to be used, based on the source address of the e-mail message. The rule base may identify which portion of the delivered e-mail message is to be used at least in part by distinguishing between an attachment to the delivered e-mail message and a body of the delivered e-mail message.

The source address may include an identification selected from a group consisting of: an identification associated with a scanner, and identification associated with an incoming fax server and an identification associated with a human user.

Optionally, at least one document may be automatically downloaded over the Internet in response to delivery of the e-mail message. The at least one document may include an Office Action, cited references and/or other documents stored on a computer system operated by a patent office.

Yet another embodiment of the present invention provides a computer-implemented method for generating an e-mail message. Information about a workflow item is displayed. The workflow item has at least one document associated with it. In response to an input from a user, an e-mail message is generated. At least one of the at least one document associated with the workflow item is automatically attached to the e-mail message.

All of the at least one document associated with the workflow item may be automatically attached to the e-mail message.

A copy of the at least one document may be automatically obtained from a document management system.

Another embodiment of the present invention provides a computer-implemented method for associating a document with a workflow item. A word processor is used to display a document. An indication of a workflow item is received from a user of the word processor. Metadata is automatically stored in association with the document. The metadata includes information identifying the indicated workflow item.

The information may be stored in a document variable. In addition, optionally, a project identification that is associated with the workflow item may be automatically ascertained. Contact information associated with the project identification may also automatically be obtained, and the contact information may be stored in the document. The contact information may be automatically obtained by using the project identification to query a client information database. Optionally, the project identification may be automatically stored in the document, such as by storing the project identification in a document variable. Automatically ascertaining the project identification may include automatically ascertaining a client/matter identification.

Another embodiment of the present invention provides a computer-implemented method for generating an e-mail message based on text selected in a document. A word processor may be used to display a document that includes information identifying a workflow item. A user may select a portion of the document and an indication of the portion of the displayed document selected by the user may be received. In response to an input from the user, an e-mail message may be generated and the portion of the displayed document selected by the user may be automatically copied into the e-mail message.

Optionally, the e-mail message may be automatically addressed. The document may further include contact information stored as metadata, and automatically addressing the e-mail message may include addressing the e-mail message according to the contact information.

The information identifying the workflow item may be used to automatically ascertain contact information. The information identifying the workflow item may be used to automatically ascertain a project identification, and the project identification may be used to automatically query a client information database for contact information.

At least one other document may be associated with the workflow item, and a user interface that lists the at least one other document associated with the workflow item may be displayed. Using the user interface, the user can select at least one of the listed at least one other document. A user-selected at least one of the listed at least one other document may be attached to the e-mail message.

For at least one of the selected at least one of the listed document, attaching the document to the e-mail message may include automatically obtaining a copy of the document from a document management system and automatically attaching the copy of the document to the e-mail message.

Another embodiment of the present invention provides a computer-implemented method for marking a document, stored in a document management system and associated with a workflow item separate from the document management system, as having been docketed. The workflow item has at least one document associated with it. Information about a workflow item is displayed. In response to an input from a user, information is stored in the document management system to indicate that at least one of the at least one document associated with the workflow item has been docketed.

A user interface may be displayed. A user may use the user interface to choose which of the at least one document associated with the workflow item is to be marked as having been docketed. The information may be stored in the document management system by storing the information in a custom field in the document management system.

Yet another embodiment of the present invention provides a computer program product for providing storing information about at least one workflow item. The computer program product includes a non-transitory computer-readable medium having computer readable program code thereon. The computer readable program includes program code configured to store, in a computer database in association with information about the workflow item, for each such workflow item, information identifying a person (an “assigned person”) who has a responsibility to complete the workflow item. The computer readable program also includes program code configured to provide, in association with the information about the workflow item, a capability for storing in the computer database information identifying a person (a “covering person”) who has a responsibility to complete the workflow item if the assigned person is unavailable to complete the workflow item.

Another embodiment of the present invention provides a system for storing information about at least one workflow item. The system includes a computer database configured to store, in association with information about the workflow item, for each such workflow item, information identifying a person (an “assigned person”) who has a responsibility to complete the workflow item. The computer database is also configured to store, in association with the information about the workflow item, information identifying a person (a “covering person”) who has a responsibility to complete the workflow item if the assigned person is unavailable to complete the workflow item.

An embodiment of the present invention provides a computer program product for generating an e-mail message. The computer program product includes a non-transitory computer-readable medium having computer readable program code thereon. The computer readable program includes program code configured to display information about a workflow item, the workflow item having at least one document associated therewith. The computer readable program also includes program code configured to, in response to an input from a user, generate an e-mail message and automatically attaching to the e-mail message at least one of the at least one document associated with the workflow item.

Another embodiment of the present invention provides a system for generating an e-mail message. The system includes a computer configured to display information about a workflow item, the workflow item having at least one document associated therewith. The system also includes a computer configured to, in response to an input from a user, generate an e-mail message and automatically attach to the e-mail message at least one of the at least one document associated with the workflow item.

Yet another embodiment of the present invention provides a computer program product for associating a document with a workflow item. The computer program product includes a non-transitory computer-readable medium having computer readable program code thereon. The computer readable program includes program code configured to use a word processor to display a document. The computer readable program also includes program code configured to receive from a user of the word processor an indication of a workflow item and program code configured to automatically store metadata in association with the document, the metadata including information identifying the indicated workflow item.

An embodiment of the present invention provides a system for associating a document with a workflow item. The system includes a word processor configured to display a document and a user interface configured to receive from a user of the word processor an indication of a workflow item. A computer program is configured to automatically store metadata in association with the document, the metadata including information identifying the indicated workflow item.

### BRIEF DESCRIPTION OF THE DRAWINGS

The invention will be more fully understood by referring to the following Detailed Description of Specific Embodiments in conjunction with the Drawings, of which:

FIG. 1 is a schematic block diagram of a workflow system and associated computer-based systems, according to an embodiment of the present invention;

FIG. 2 is an exemplary screen display showing information provided by a case document and information integration system, according to an embodiment of the present invention;

FIG. 3 is a schematic block diagram illustrating flow of information through several of the computer-based systems shown in FIG. 1, according to an embodiment of the present invention;

FIG. 4 is an exemplary screen display provided by an IP assistant console program, according to an embodiment of the present invention;

FIGS. 5-6 are exemplary screen displays provided by a workflow engine, as defined by a workflow definition, of FIG. 1, according to an embodiment of the present invention;

FIG. 7 is a schematic block diagram of tables used by a workflow system, according to the prior art;

FIG. 8 is a schematic block diagram of tables used by a workflow system, according to an embodiment of the present invention;

FIGS. 9-11 are exemplary screen displays provided by an attorney console program, according to an embodiment of the present invention;

FIG. 12 is an exemplary screen display provided by a workflow engine, as defined by a workflow definition, of FIG. 1, according to an embodiment of the present invention;

FIG. 13 is an exemplary screen display illustrating an e-mail message generated according to an embodiment of the present invention;

FIG. 14 is an exemplary screen display illustrating selecting text in preparation for generating an e-mail message, according to an embodiment of the present invention;

FIG. 15 is an exemplary automatically generated screen display, according to an embodiment of the present invention;

FIG. 16 is an exemplary screen display provided by provided by a workflow engine, as defined by a workflow definition, of FIG. 1, according to an embodiment of the present invention;

FIG. 17 is an exemplary “basic search” screen display provided by the case document and information integration system, according to an embodiment of the present invention;

FIG. 18 is an exemplary “advanced search” screen display provided by the case document and information integration system, according to an embodiment of the present invention;

FIG. 19 is an exemplary dialog box by which a user may receive information about documents attached to a workflow item, attached additional documents to the workflow item and remove documents attached to the workflow item; and

FIG. 20 is an exemplary display provided by a paralegal console program, according to an embodiment of the present invention.

### DETAILED DESCRIPTION OF SPECIFIC EMBODIMENTS

In accordance with embodiments of the present invention, methods and apparatus related to a workflow system are provided.

### DEFINITIONS

As used in this description and the accompanying claims, the following terms shall have the meanings indicated, unless the context otherwise requires.

Console—a software program, executed by a processor, so as to provide a graphical user interface (GUI) to selected information. Some or all the information may be displayed in a read-only mode. The console may include controls by which a user may modify some or all of the displayed information. Most consoles are role-specific. That is, the controls provided and the set of information displayed are based on the role of the user. A console may include tabs, radio buttons or other controls by which the user may select sets or types of information to be displayed or modified. A console may display controls by which the user may sort displayed information. Exemplary consoles, in relation to the present invention, include an attorney console and a paralegal console, both for displaying information about workflow items that the attorney or paralegal is responsible for, and an IP manager console for overseeing all workflow items.

Docket/docketing—storing, in a docket database, a due date associated with a document. Some incoming correspondence involves due dates. For example, an Office Action from a governmental patent or trademark office typically has an associated date by which a response must be filed in order to be considered timely. Some due dates are extendable, such as by paying an extension-of-time fee or by filing petition. Some documents have due dates that are imposed by an unofficial source, such as a client or a law firm. For example, a client may request that a patent application be filed by an arbitrary date, or a law firm may choose to impose an arbitrary date by which a patent application must be filed. When a document having or implying a due date is received, the due date is typically recorded in a docketing database. When the due date is so recorded, the document and the due date are said to have been “docketed.”

Various roles may be defined, with respect to a workflow. Exemplary roles are listed in Table 1. Additional or different roles may be used, as discussed herein or as may be appropriate for a given law firm or other organization.

Embodiments of the workflow system described herein may be used for various workflows, such as incoming correspondence, outgoing reporting letters, handling Office Actions and drafting patent applications. Details of one such embodiment are described in relation to handling incoming correspondence; however, software, data structures, information display consoles, algorithms, mechanisms, etc. described herein, or variations thereof, may be used to handle additional or other workflows.

TABLE 1

| Role | Description |
|---|---|
| IP Assistant | Reviews incoming correspondence; manages new workflow |
| | item creation |
| Assigned | Dockets due dates; stores copies of incoming |
| Paralegal | correspondence in a document management system; drafts |
| | (template) reporting letters |
| Working | Reviews incoming correspondence for urgency; studies |
| Attorney | incoming correspondence; performs substantive legal work; |
| | augments draft reporting letters; sends reporting letters |
| Covering | Ensures due dates are not missed and incoming |
| Attorney | correspondence is handled in a timely manner, while the |
| | working attorney is unavailable |
| Supervising | Supervises work of working attorney |
| Attorney | |
| Paralegal | Expedites processing of urgent workflow items |
| Manager | |

Broadly speaking, an incoming correspondence workflow is intended to ensure that each piece of incoming correspondence is handled in a timely manner by each person or functional department that has a responsibility, with respect to each stage of processing that particular correspondence. For example, if the correspondence relates to a particular project (typically identified in a law firm by a particular client/matter identification), and a particular attorney has been designated as the working attorney, a particular paralegal has been designated as the assigned paralegal and another particular attorney has been designated as the supervising attorney for this project, the workflow ensures these people are notified at appropriate stages of the workflow, and these people can indicate completion of their respective stages of the workflow.

According to certain business operations, such as many operations in most law firms, a specific person (not just any person in a functional department) is typically responsible for completing each stage of a workflow. This one-responsible-person-per-stage scheme is often implemented for accountability purposes and to decrease the likelihood that a stage is not completed on time because each of the people in a function department believes another person in the department is handling the workflow item.

In addition, according to embodiments of the present invention, if a responsible person is absent, such as when the person is on vacation, a covering person is notified when the workflow reaches a stage that imposes a responsibility on the covered person. Although the covering person may not necessarily perform substantive work, i.e., the covering person may not necessarily discharge the responsibility of the covered person, the covering person is notified so she/he may: contact the covered person and arrange to have the work done or obtain sufficient information so the covering person may perform the work; notify the supervising attorney or other supervisor and arrange to have the work done; contact the client, patent office, court, etc. and arrange for an extension of time; or otherwise ensure deadlines are met or extended and the law firm's timeliness of response to correspondence guidelines are met.

Embodiments of the present invention also support “supervising attorneys;” however, a supervisor has a fundamentally different relationship to a workflow item than a working attorney has to the workflow item. The supervisor may view the current stage of a workflow item, and the supervisor may actually supervise people responsible for completing stages of workflows. However, within the workflow system, the supervisor can not complete a stage of a workflow.

In embodiments of the present invention, a covering attorney may complete a stage of workflow. However, workflow items that are covered are segregated from the covering attorney's own workflow items. A console program, according to the present invention, displays covered workflow items separately from workflow items for which an attorney is the working attorney.

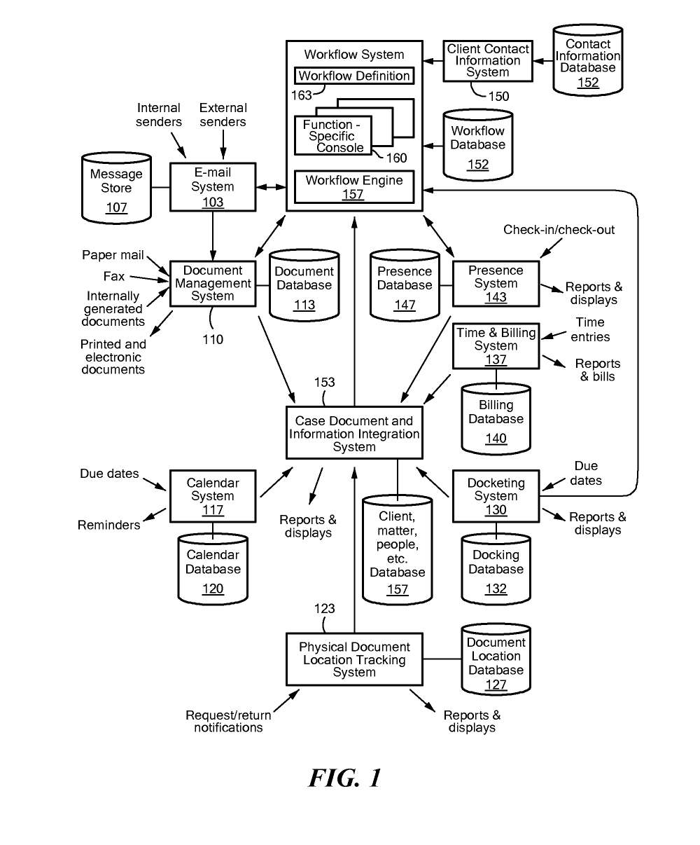

FIG. 1 is a schematic block diagram of a workflow system 100 and associated other computer-based systems with which the workflow system 100 may interact, according to an embodiment of the present invention. The workflow system 100 may serve, for example, a law firm or another organization with similar workflow needs.

Among the other computer-based systems are an e-mail system 103 and its associated message store 107. Exemplary e-mail systems include Microsoft Outlook and Microsoft Exchange Server. The e-mail system 103 receives e-mail messages from external senders, such as clients, vendors, courts, patent offices, foreign associates and the like. The e-mail system 103 also receives e-mail messages from internal senders, such as attorneys and paralegals who work for the law firm. Scanners, computer-based incoming facsimile (“fax”) servers and other equipment (not shown) within or associated with the law firm may also generate internal e-mail messages, as described below. The e-mail system 103 also enables users of the system to send e-mail messages to external recipients, such as patent offices, foreign associates, vendors and clients.

A document management system 110 and its associated document database 113 stores and catalogs documents created, received or otherwise maintained by the law firm. Many such documents are text-based, word processed documents. However, other documents may be spreadsheets, images, documents in proprietary formats (such as Portable Document Format (“PDF”)), audio or video recordings and the like. Documents stored in the document management system 110 may subsequently be printed and sent to clients, patent offices, etc. Similarly, electronic versions of the documents, such as PDF images of the documents, may be sent as electronic attachments to e-mail messages.

The documents in the document management system 110 are typically organized according to client, and they are typically further organized by matter. When a document is created or entered into the document management system 110, the document is assigned a project identification, a creation date, an author and other metadata defined by the vendor of the document management system 110. The process of assigning this metadata (and sometimes including the process of creating or entering the document into the document management system 110) is sometimes referred to as “profiling” the document. The project identification may be a unique identifier or a combination of identifiers, such as a client number and a matter number. Incoming and outgoing paper correspondence is often scanned, and the scanned images are stored in the document management system 110. Similarly, incoming e-mail messages and copies of outgoing e-mail messages may be moved from the e-mail system 103 to the document management system 110, so the messages may be profiled. Thus, the term “document” encompasses conventional documents, such as word-processed documents and spreadsheets, as well as e-mail messages, scanned images, and any other type of electronic file that can be stored in the document management system 110. An exemplary document management system 110 is available from Autonomy Interwoven, San Jose, Calif. 95134 under the trade name WorkSite.

A calendar system 117 and an associated calendar database 120 may be used to keep track of individual attorneys' and individual paralegals' action items, such as due dates by which to respond to Office Actions or pay patent issue fees. Users may manually enter due dates as calendar entries, and the calendar system 117 may remind the users of these due dates. Microsoft Outlook and Microsoft Exchange Server may be used to implement the calendar system 117.

Although a “paperless office” may be an ideal that some law firms strive for, most law firms find that at least some documents, prototypes, samples, etc. must be maintained in their physical forms, at least temporarily until they can be digitized and stored in the document management system 110. A physical document location and tracking system 123 and its associated database 127 may be used to keep track of the physical location of each such document, file folder, etc. For example, the location may indicate a floor, file room, shelf; file cabinet, drawer, office or the like (or a combination thereof) where a physical document is currently stored. Much like a library check-out system, the physical document location and tracking system 123 may be updated when a document is moved to another location, such as when an attorney temporarily or permanently moves a file folder to her office, so as to have ready access to documents in the file folder. The physical document location tracking system 123 may be queried, such as via a graphical user interface (GUI), to ascertain the current location of a document or to request transfer of a file folder. Upon receiving a request for a file folder, the system 123 may send an e-mail message to a support organization or person within the law firm, whose responsibility includes physically moving file folders.

As noted, some incoming correspondence reflects due dates, such as a date by which a brief must be filed or a fee must be paid. Some such dates are extendable upon petition and/or upon payment of an extension of time fee. Most law firms use docketing systems, such as docketing system 130 and its associated database 132, to keep track of these due dates. Information in the docketing system 130 is typically associated with project identifiers. The docketing system 130 may also be used to store information identifying an attorney who has been assigned responsibility for handling each project (i.e., client/matter), as well as a supervising attorney and an assigned paralegal. In some law firms, both a senior and a junior supervising attorney may be assigned to a project. The information about the assigned attorney, the assigned paralegal, etc. is typically manually entered as each new project entry is created in the docketing system 130. Computer-based docketing systems are available from several vendors, including Computer Packages, Inc., Rockville, Md. 20850.

Inasmuch as law firms often bill clients based on the amount of time attorneys and paralegals work on cases for the clients, a time and billing system 137 and its associated database 140 may be used to record attorney and paralegal time and to generate reports and bills. An exemplary time and billing system is available from Tikit, London, England under the trade name Carpe Diem.

A presence system 143 and its associated database 147 may be used to keep track of whether individual people who work at the law firm are currently in the office or not. In one embodiment, the presence system 143 prompts a user when the user's computer is started or the user logs on to the computer. If the user responds to the prompt with an indication that the user plans to remain in the office, the user is marked “present” in the presence database 147. Similarly, when the user logs off or initiates shut down of his computer, the presence system 143 may prompt the user to enter an “out of the office” message, possibly including an expected return time or date. This information is stored in the database 147, and the user is marked “absent” in the presence database 147. Users or computer programs may query the presence system 143, such as via a web-based user interface or an application programming interface (API), to ascertain the presence status of a given member of the law firm. The presence system 143 may display or return the “out of the office” message and the expected return time/date previously entered.

Optionally, when a user leaves the office or logs out, the presence system 143 may prompt for, and store, an identity of another person who the user designates as “covering” for the user during the user's absence. For example, when an attorney leaves for vacation or a planned medically-related absence, the attorney may designate another attorney to have responsibility for ensuring urgent matters are taken care of during the departing attorney's absence. Upon being queried, the presence system 143 may display or return the identity of the covering attorney, along with the “out of office” message and expected return time/date. The identity of the covering individual may be used to significant advantage by the workflow system 100.

A client contact information system 150 and its associated database 152 may be used to store contact information, such as postal address, telephone number, fax number, e-mail address (including “to,” “cc” and “bcc”), etc., for each client. This information may include separate contact information for each of the client's matters. The contact information, particularly the “cc” or “bcc” information, may identify a person separate from the client, such as a client's funder or an accountant or the law firm partner who is to receive copies of correspondence sent to the client.

The array of computer-based systems and databases 103-152 may make it difficult for a user to easily obtain a desired piece of information, due to the number of user interfaces involved. A case document and information integration system 153 (also referred to as “CFIS”) and its associated database 157 may provide integrated access to much or all of the information stored in the other systems 103-152. As shown in FIG. 1, the document and information integration system 153 has interfaces to the other systems 103-152; thus, the document and information integration system 153 may query the other systems and display information fetched from one or more of these systems on a single screen.

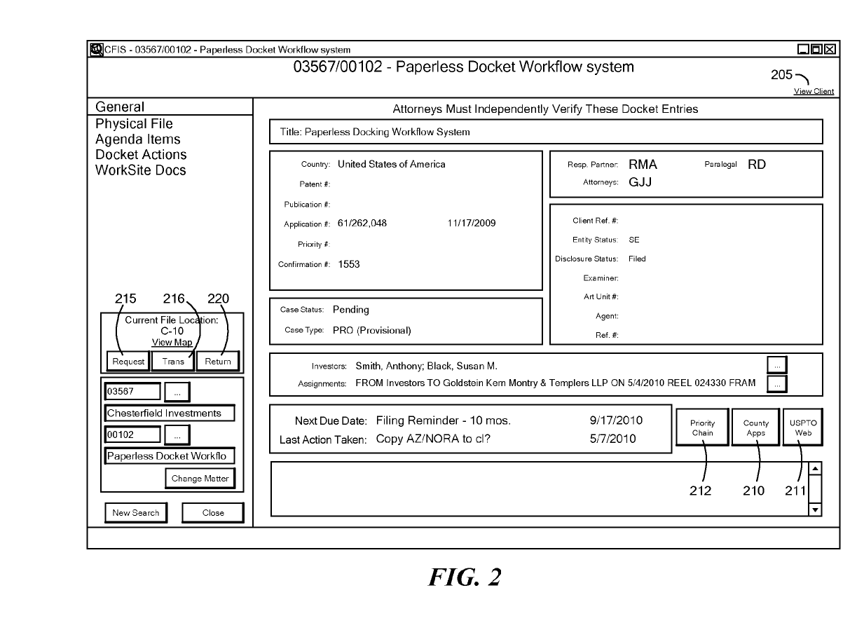

For example, a user may enter a client/matter number into the document and information integration system 153, and the system may fetch: docket due dates related to the identified matter from the docketing system 130; client contact information related to the identified matter from the client contact system 150; information about the location of related physical documents from the physical document location tracking system 123; and information about the amount of time expended or billed to the client from the time and billing system 137. The fetched information may be displayed in a single window, as exemplified in FIG. 2. The window may include controls by which the user may request additional information, such as more details about the client 205 or related patent applications filed in other countries 210.

Activating another control 211 may launch a browser to display a web page provided by a patent office. If a patent number or publication number is stored in the docketing system 130, the web page may be automatically queried or passed the number as a parameter to display information about the patent or application. Yet another control 212 may cause the docketing system 130 to be queried to obtain provenance information about the identified patent or application as client/matter number, application number and filing dates. Similarly, the window may include controls to request transfer of the physical file to the user 215, to another person 216 or to request that the physical file be picked up from the user and returned to its normal storage location 220.

Returning to FIG. 1, the workflow system 100 includes a workflow engine 157, one or more function-specific “consoles” 160, additional function-specific displays, a workflow definition 163 and a workflow database 170. A workflow item is created when an incoming correspondence is received. Each workflow item is represented by a record in the workflow database 170.

The workflow definition 163 defines the stages of each type of workflow and how the workflow engine 157 should handle each type of workflow item. The workflow definition 163 defines an order in which each type of workflow item is to be handled by various types of people, such as paralegals and attorneys, and what information is to be displayed or provided to these people at the various stages of the workflow item. The workflow definition 163 is typically created using software tools provided by the vendor of the workflow engine 157. Some user displays generated by the workflow engine 157 may include controls (such as buttons) that initiate custom scripts or other software, which may be stored along with the workflow definition 163.

The workflow definition 163 may be in the form of rules for routing workflow item types and the like. However, the particular people who have responsibility for completing each stage of a particular workflow item, i.e., the particular working attorney or assigned paralegal who must complete each stage, are defined in the workflow database 170, inasmuch as this information is specific to each workflow item. The workflow definition 163 may be stored in the workflow database 170 or elsewhere.

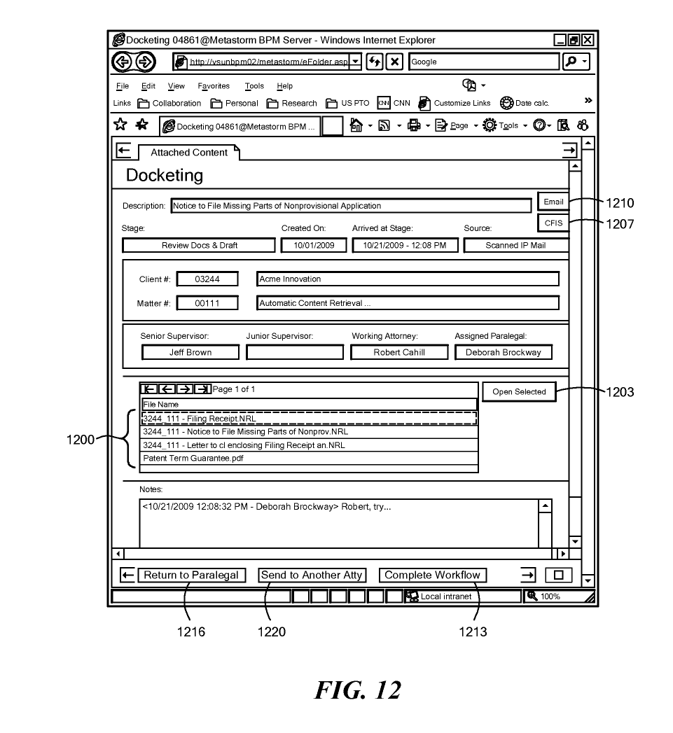

As each workflow item progresses through its respective stages, data is stored or modified in the workflow database 170 to reflect the then-current person who is responsible for the workflow item and the stage or completion of the workflow item itself Dialog boxes, as exemplified by a dialog box shown in FIG. 12, may be used by users to indicate that their respective stage of a workflow has been completed, such as by invoking a “Complete Workflow” control 1213. Alternatively, the user may send the workflow item to another user by invoking a “Return to Paralegal” control 1216 or a “Send to Another Atty” control 1220.

### Generating Workflow Items

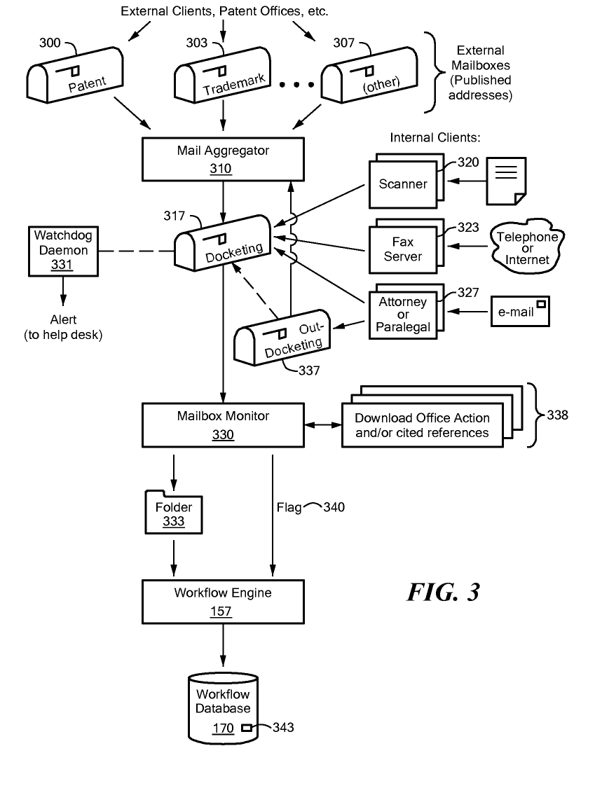

FIG. 3 is a schematic block diagram illustrating flow of information through several of the computer-based systems shown in FIG. 1 and, in particular, a process for creating workflow items in response to receipt of incoming correspondence. One or more e-mail boxes 300, 303 and 307 with published e-mail addresses (such as Patents@Sunsteinlaw.com) may be designated to receive incoming correspondence from external sources, such as patent offices, trademark offices, clients or foreign associates. A mail aggregator 310 may monitor these mailboxes 300-307 and forward all incoming e-mail messages, as attachments, to a single docketing mailbox 317. Alternatively, the mailboxes 300-307 may be configured to automatically forward incoming messages as attachments to the docketing mailbox 317.

Paper-based incoming correspondence may be scanned by a scanner 320, and the scanner 320 may send an electronic copy of each scanned document as an attachment to an e-mail message to the docketing mailbox 317. The scanned document attachment may be in any suitable form, such as a PDF document. If a single piece of correspondence includes several distinct papers, such as a cover letter, an Office Action and several prior art references, all the papers may be scanned as a single document or each paper may be scanned as a separate document. In either case, the scanned document(s) is(are) attached to an e-mail message sent to the docketing mailbox 317. More than one scanner 320 may be used, depending on the volume of incoming paper mail, office layout and other considerations.

Incoming fax correspondence may be received by one or more computer-based fax servers 323. As with the scanners 320, the fax servers 323 may send electronic copies of the incoming faxes as e-mail attachments to the docketing mailbox 317. Faxes received by paper-based fax machines may be treated as incoming paper correspondence and scanned.

Clients, foreign associates, patent examiners and others may send e-mail messages directly to attorneys or paralegals 327. The receiving attorneys and paralegals 327 may review the incoming e-mail messages, such as to determine if a given message is urgent. The attorneys and paralegals 327 may then forward the incoming messages (as attachments to new e-mail messages) to the docketing mailbox 317. If an attorney or paralegal 327 determines that an incoming e-mail message is urgent, the recipient 327 may mark the e-mail message to the docketing mailbox 317 as urgent, using a native flag or other indicator typically provided by the e-mail system 103 (FIG. 1). Optionally or alternatively, the attorney or paralegal 327 may include comments related to the urgency, client/matter number, handling instructions, etc. in the subject line and/or body of the conveying e-mail message.

Thus, all incoming correspondence, regardless of the path the correspondence took to reach the law firm, ultimately is represented by e-mail messages in the docketing mailbox 317. In some of these e-mail messages, such as messages forwarded by attorneys and paralegals 327 to the docketing mailbox 317, the bodies of the messages are likely to contain significant contents, such as instructions or client/matter numbers. Most or all of the messages and/or their attachments received in the docketing mailbox 317 are typically eventually stored in the document management system 110.

A mailbox monitor 330 monitors the docketing mailbox 317. The mailbox monitor 330 may be implemented as a script, a cron job, etc. that is executed at intervals, such as every 15 seconds or another time interval consistent with the law firm's responsiveness to correspondence guidelines. When the mailbox monitor 330 detects that an an e-mail message has been deposited in the docketing mailbox 317, the mailbox monitor 330 saves the contents of the e-mail message (including any attachment) or only its attachment as a file in a folder 333. Whether the entire contents or only the attachment is saved is determined by the source address of the e-mail message.

A watchdog daemon 331 may periodically or occasionally check the docketing mailbox 317, as well as the other mailboxes 300-307. If the watchdog daemon 331 detects one or more e-mail messages in one of the mailboxes 300-307 or 317 that were also present the last time the watchdog daemon 331 checked these mailboxes, the watchdog daemon 331 may conclude the mailbox monitor 330 has failed or is executing slowly or another error has occurred. The watchdog daemon 331 may issue an alert, such as by sending an e-mail message to a helpdesk.

Recall that each e-mail message originally sent to an external mailboxes 300-307 is forwarded, as an attachment to a new e-mail message, to the docketing mailbox 317. Similarly, scanned documents and faxes are sent as attachments to e-mail messages to the docketing mailbox 317. Thus, the bodies (as distinct from the attachments) of conveying e-mail messages likely contain no useful information; however, the “from” addresses of these messages identify the types of attachments being conveyed. For example, a “from” address (such as ipmail@sunsteinlaw.com) associated with the scanner 320 indicates that the correspondence was originally received in paper form. On the other hand, the bodies of e-mail messages from attorneys and paralegals (forwarding e-mail messages received directly from clients, etc.) may contain handling instructions and the like. Thus, which part(s) of an e-mail message received in the docketing mailbox 317 should be saved can be determined from the source address of the e-mail message.

For each e-mail message processed by the mailbox monitor 330, the mailbox monitor 330 consults a “helper file” (exemplified in Table 2), which instructs the mailbox monitor 330 how to handle the e-mail message, based on the message's source (i.e., “from”) address. The source address is compared to entries in the first column of the helper file. If a source address matches a helper file entry, the second column of the entry is used to determine how to handle the e-mail message. “Attachment” in the second column instructs the mailbox monitor 330 to store a copy of the attachment(s) in the folder 333. “Envelope” in the second column instructs the mailbox monitor 330 to store a copy of the entire contents of the e-mail message (including any attachments) in the folder 333. For example, a Microsoft Outlook e-mail message may be stored as a file having a MSG file type. If the source address is not listed in the helper file, for example, if the e-mail message is from an internal sender (i.e., an attorney or a paralegal), the mailbox monitor 330 processes the message as though the table entry were “envelope.”

Optionally, the mailbox monitor 330 may automatically obtain documents, such as Office Actions or cited references, related to an e-mail message being handled by the mailbox monitor 330, such as by downloading the documents from a patent office web site, storing the documents in the folder 333 and associating the documents with the e-mail message. Such optional processing may be performed by processes represented by boxes 338.

The third column of the helper file indicates a source type of the e-mail message. For example, if an attorney or paralegal sends a reporting message to a client via e-mail, the attorney or paralegal may send a copy of the message to an outdocketing mailbox 337, which is processed by the mailbox monitor 330, thereby eventually generating a workflow item for the outgoing correspondence. (The mail aggregator 310 may process messages received by the outdocketing mailbox 337 the same way the mailbox monitor 330 processes messages received by the other mailboxes 300-307. Alternatively, the outdocketing mailbox 337 may be configured to automatically forward, as attachments, messages to the docketing mailbox 317.) Ultimately, the copy of the reporting e-mail message may be stored in the document management system 110.

TABLE 2

| SMTP/E-mail | Handling | Source |
|---|---|---|
| ipmail@sunsteinlaw.com | attachment | Secretary Scanned |
| | | Mail (320) |
| ipmaildocketing@sunsteinlaw.com | attachment | Scanned IP Mail (320) |
| trademarks@sunsteinlaw.com | attachment | Trademarks |
| | | Mailbox (303) |
| patents@sunsteinlaw.com | attachment | Patents Mailbox (300) |
| genifaxmessageserver | attachment | Fax (323) |
| outdocketing@sunsteinlaw.com | envelope | Outgoing Docketing |
| | | (337) |

When the mailbox monitor 330 creates a file in the folder 333, the mailbox monitor 330 also triggers the workflow engine 157 to generate a workflow item. For example, the workflow engine 157 provided by Metastorm may be triggered by raising a flag 340 via the eRaiseFlag utility. The mailbox monitor 330 passes parameters to the workflow engine 157 for the new workflow item, including identifying the file created in the folder 333 (i.e, a path to the file in the folder 333) and the source information from the third column of the helper file. If any related documents were automatically obtained by the mailbox monitor 330 or other processors 338, references to these documents are also passed to the workflow engine 157.

The workflow engine 157 creates a workflow item 343 in the workflow database 170. The workflow item 343 contains a reference to the path to the file(s) in the folder 333 and the source information from the third column of the helper file. Thus, as a result of automatically checking for delivery of an e-mail message to at least one predetermined e-mail address, such as one of the mailboxes 300-307 or the docketing mailbox 317, a workflow item 343 is automatically creating, based at least in part on a source address of an e-mail message delivered to the at least one predetermined e-mail address.

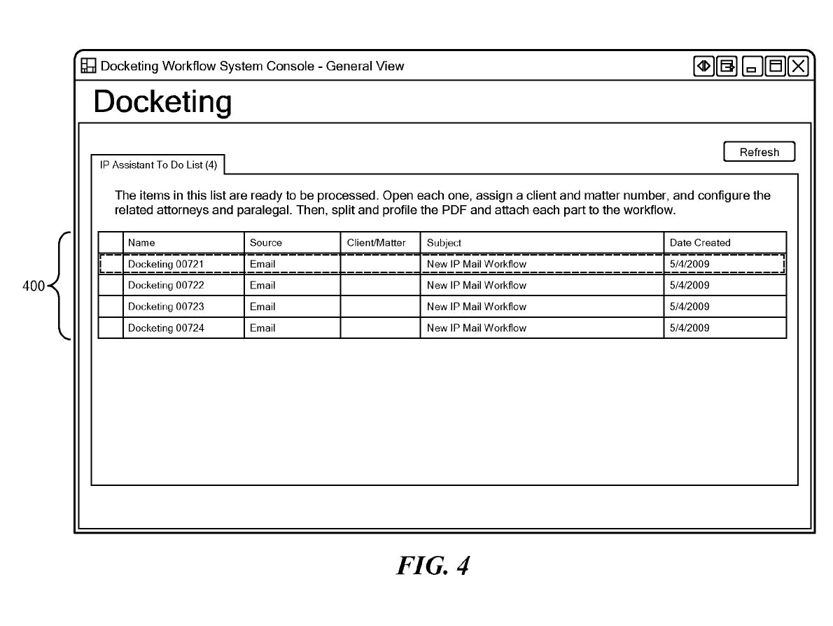

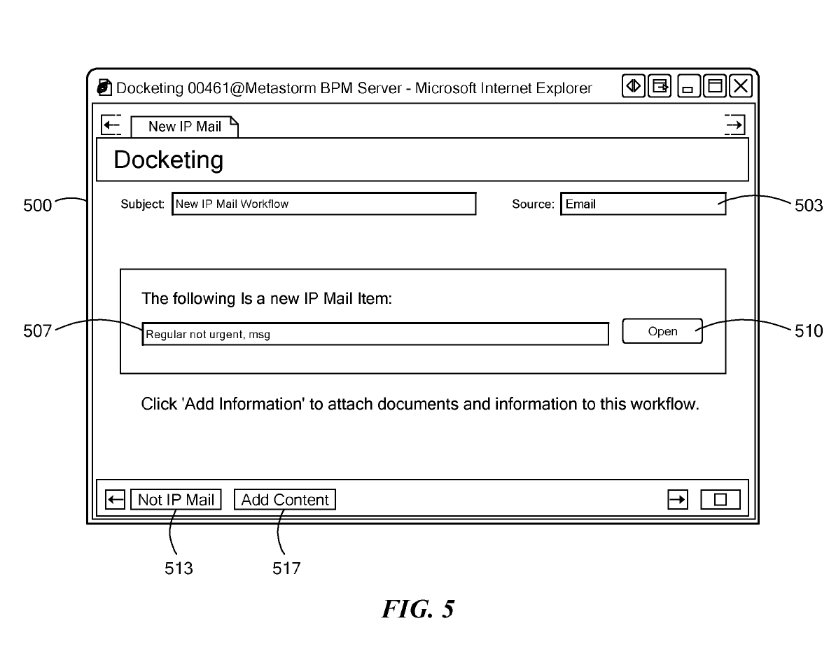

The workflow item 343 is then queued to be processed by an IP assistant. An IP assistant console provides a user interface, exemplified by the screen display shown in FIG. 4. The console lists workflow items 400 queued for the IP assistant. Although the workflow items 400 are queued, in that they may be listed in time-order of their creation, the IP assistant may process the workflow items in any order. When the IP assistant selects one of the workflow items 400 to process, information about the selected workflow item is displayed in a window exemplified in FIG. 5. For example, the source of the workflow item is displayed in a source box 503. Exemplary sources include the items listed in the third column of Table 2. The file name(s) of the file(s) created in the folder 333 is displayed in a third box 507. The IP assistant may cause the message to be opened and displayed by invoking an “open” button 510.

Based on the information available to the IP assistant, the IP assistant may decide that the workflow item is spurious because, for example, it was precipitated by a junk e-mail message delivered to the Patents mailbox 300. In this case the IP assistant may invoke a “Not IP Mail” button 513, and the IP assistant's phase of completing the workflow item is considered done. The workflow item is queued to an IP manager or other person (a “workflow disposer”) designated to review apparently spurious workflow items. The workflow disposer may ultimately mark the workflow item for removal from the workflow systems, or she may return the workflow item to the IP assistant. The workflow disposer may have more training and knowledge than an IP assistant, but the workflow disposer's time may be less valuable than that of an attorney. Thus, decisions to remove workflow items may be made by a person intermediate a relatively untrained IP assistant and a relatively expensive attorney.

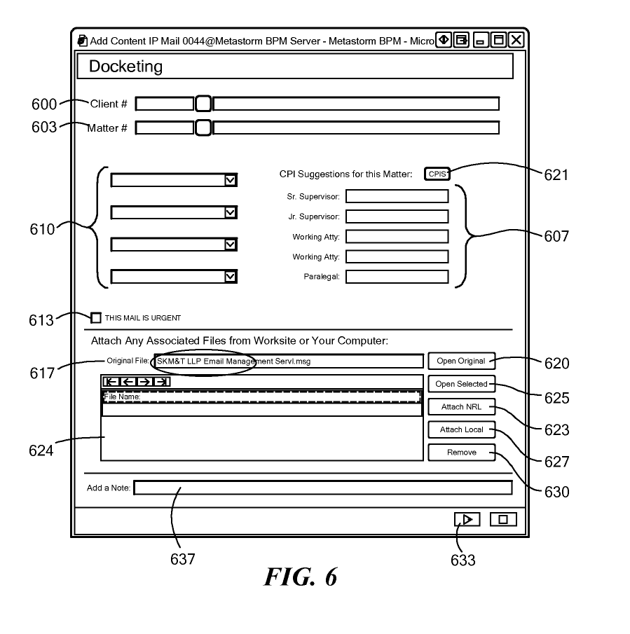

If the IP assistant decides the workflow item is not spurious, the IP assistant may invoke an “Add Contents” button 517 to invoke a software utility, an exemplary user interface screen of which is shown in FIG. 6, to further process the workflow item 343. The IP assistant may enter the project identification, which in the present embodiment includes a client number 600 and a matter number 603. The project identification may be evident from the subject line or contents of the e-mail message. For example, messages from foreign associates typically prominently include the law firm's project identification, such as in the subject line or within the first few lines of the body of the e-mail message.

Based on the entered project identification, the utility queries the docketing system 130 to ascertain a suggested working attorney, supervising attorney and assigned paralegal. Recall that the docketing system 130 may store information identifying a working attorney, a supervising attorney and an assigned paralegal for each project. This information from the docketing system 130 may be displayed in a read-only portion 607 of the user interface. This information may also be used to pre-select entries in drop-down lists of all available attorneys and paralegals in a read-write portion 610 of the user interface. The IP assistant may accept the suggested values in the read-write portion 610, or the IP assistant may override the suggested values by selecting another attorney or paralegal (as appropriate) for each role (i.e., senior supervising attorney, junior supervising attorney (if any), working attorney and assigned paralegal). In other embodiments, more or fewer roles may be used. For example, both a junior and a senior paralegal may be used.

If the correspondence includes an indication that it is urgent, or if the IP assistant otherwise determines that the correspondence is urgent, the IP assistant may activate an urgent control 613, which will mark the workflow item as “urgent.”

Recall that the workflow item contains a reference to a path to one or more files in the folder 333 (FIG. 3) that contain the original correspondence (or a scanned image thereof) that precipitated this workflow item. Information about this correspondence is displayed in a box 617. The IP assistant may open the correspondence by invoking an “Open Original” control 620, which causes the correspondence to be displayed in a separate window (not shown). The IP assistant may, therefore, read the correspondence to ascertain, for example, an associated project identification, attorney or paralegal to whom the correspondence was addressed, urgency, etc.

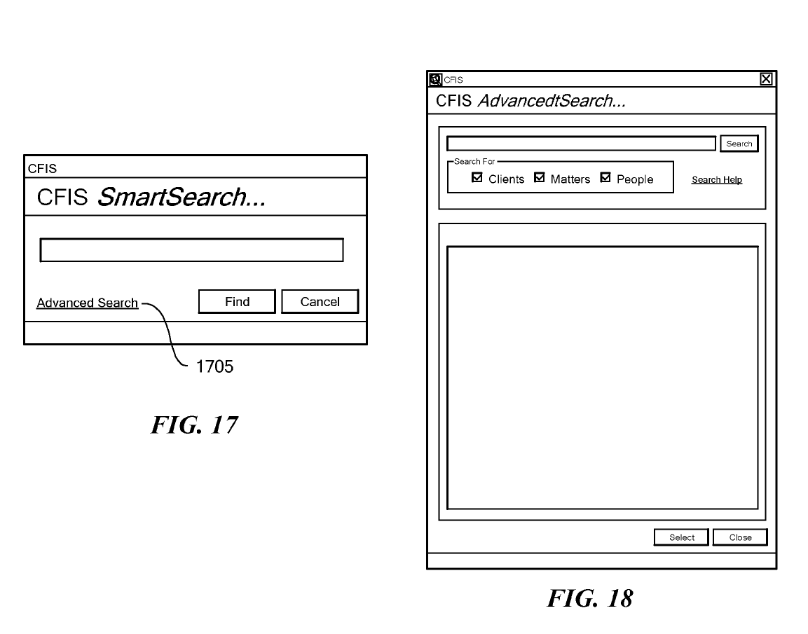

If no project identification is evident in the correspondence, the IP assistant may use other information, such as a patent application number, patent application title, inventor name, etc, included in the correspondence to determine the corresponding project identification. The case document and information integration system 153 (FIG. 1) may be consulted to assist in making this determination. A control 621 may be used to activate the document and information integration system 153. If the client and/or matter number have been entered in the boxes 600 and/or 603, this information is passed to the document and information integration system 153, and the system 153 uses this information to look up other information about this project. On the other hand, if the client and matter number boxes 600 and 603 are blank, the document and information integration system 153 prompts for search criteria, such as client name, project title, etc. and then searches for projects that match the entered search criteria. Exemplary dialog boxes for soliciting search criteria are shown in FIGS. 17 and 18. The “Advanced Search” dialog box of FIG. 18 may be displayed in response to a user invoking a corresponding control 1705 in the “Basic Search” dialog box of FIG. 17.

Once the IP assistant determines the corresponding project identification, the IP assistant may store the correspondence in the document management system 110 (FIG. 1). If the correspondence consists of several papers that were scanned as a single document, the IP assistant may profile each of the papers separately in the document management system 110. Some correspondence, such as e-mail messages from the United States Patent and Trademark Office (US PTO) may simply refer to projects, such as pending patent applications, by a reference identifier, such as a patent office application number, without including any substantive documents. In such cases, the IP assistant may access an electronic system, such as the US PTO Patent Application Information Retrieval (“PAIR”) system, to download copies of relevant documents, such as Notices to File Missing Parts, Office Actions and cited prior art references, Notices of Allowance, etc. The IP assistant may profile each of the downloaded documents separately in the document management system 110.

Some correspondence, such as electronic notification of Office Actions from the US PTO, may include information about several matters in a single message. In such a case, the IP assistant processes each of the matters separately. For example, the IP assistant may handle the first project listed in the electronic notification as described, i.e. using the workflow item created by the workflow engine 157. Then, the IP assistant may forward, as an attachment, a copy of the electronic notification to the docketing mailbox 317 for each of the second and subsequent projects listed in the electronic communication from the patent office. As noted, each such forwarded message precipitates generation of a separate workflow item, and each of these workflow items is queued to be processed by the IP assistant. The IP assistant may then process each of the other projects listed in the communication from the patent office in the context of its own separate workflow item.

Currently, the US PTO does not provide an application programming interface (API) for downloading Office Actions, cited prior art references, etc. However, in the future the US PTO may provide such an API, and other patent offices may provide such an API now or in the future. If and when such an API is available, the mailbox monitor 330, the workflow engine 157 or another component (such as a processor 338) may automatically download Office Actions, cited references, etc., in response to receiving an electronic communication from the patent office. The “from” address of the electronic communication may be used to determine which processor 338 to invoke. For example, each processor 338 may be configured to parse communications from a corresponding US or other patent office and access a corresponding web site or API/URL.

The electronic communication from the patent office may be parsed to automatically determine an application number, project identification, docket number, URL or some other identifier associated with the case, and this information (together with appropriate user credentials previously established with the patent office) may be used to access the API or a web interface provided by the patent office to provide such documents. Alternatively, the information from the electronic communication, such as the application number, (together with the user credentials) may be used to access Private PAIR, and information from the Private PAIR web pages may be “scraped” using conventional web page parsing techniques to locate and then download desired documents, such as Office Actions and cited references, such as from the “Display References” tab of the Private PAIR web page. Similar data is available from other patent office web sites, such as https://register.epoline.org/espacenet.

Such automatic downloading of Office Actions, cited references or the like may obviate the need for the IP assistant to review workflow items created as results of electronic communications from patent offices or at least obviate the need for the IP assistant to download the documents from the patent office server. In these cases, the working attorneys and other workflow handling people may be automatically determined, such as from the client/matter numbers, and workflow items may simply be automatically passed to the next people designated to handle them.

As noted, in a law firm, documents are typically stored in a document management system 110. However, rather than sending copies of these documents as e-mail attachments within the firm, links to the documents are typically sent. For example, a link to a document stored in a WorkSite document management system consists of a small text file (typically having a file name extension of “NRL”) that contains information with which the document management system 110 may locate the document. Word processors (such as Microsoft Word) and other office automation software (such as Microsoft Outlook), and sometimes operating systems, are often augmented to support such links.

Returning to the utility program's user interface screen of FIG. 6, the IP assistant may associate one or more documents stored in the document management system 110 with the newly created workflow item 343 by invoking an “Attach NRL” control 623. Typically, the IP assistant attaches links to the documents that were just profiled, i.e., the documents received with the correspondence. However, additional or fewer documents may be attached to the workflow item.

When invoked, the Attach NRL control 623 may invoke a script that activates a client-side dynamic link library (DLL) that interacts with the document management system 110 to display a document chooser window (not shown), by which one or more documents from the document management system 110 may be selected. Links to the selected documents are stored in association with the newly created workflow item. A list of documents associated with the workflow item appears in a sub-window 624. A document associated with the workflow item may be opened by selecting it in the sub-window 624 and invoking an “Open Selected” control 625.

Local files, i.e., files stored on the IP assistant's computer or otherwise accessible via the IP assistant's computer (but not stored in the document management system 110) may also be associated with the newly created workflow item by invoking an “Attach Local” control 627. Erroneously attached documents may be removed from the workflow item with a “Remove” control 630.

Once the IP assistant completes the initial review of the correspondence, assigns the working attorney, etc., and attaches the appropriate documents to the workflow item, the IP assistant may send the workflow item to the working attorney and to the assigned paralegal in parallel by invoking a “Send to Attorney and Paralegal” button 633. The workflow item 343 may then be at a stage where the paralegal has a task to perform (such as drafting a reporting letter or docketing a due date) before the workflow item is ready for the attorney's attention.

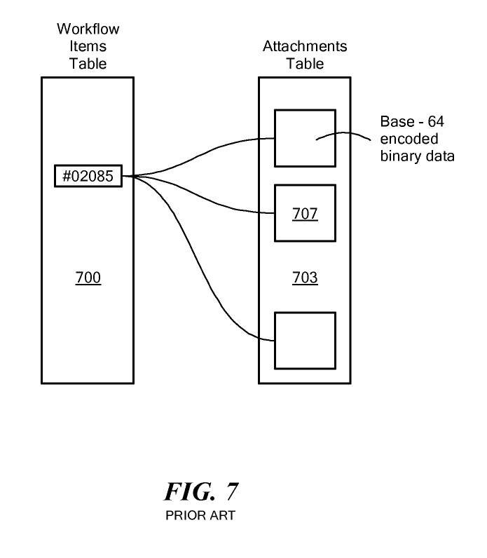

Various data structures may be used to associate documents or links to documents with workflow items. For example, the workflow system 100 may store information about workflow items in a relational database. As is well known, a relational database includes tables. Workflow items may be represented by entries in one or more such tables. For example, as shown schematically in FIG. 7, a workflow items table 700 may represent workflow items, and an attachments table 704 may store documents associated with ones of the workflow items in the workflow items table 700. In one implementation, each attachment is stored in the attachments table 703 as base-64 encoded binary data. Thus, a link to a document in the document management system 110 (such as the contents of an NRL file) may be stored in one of the entries 707 in the attachments table 703. Similarly, a local file attached by the IP assistant may be stored as base-64 encoded binary data in another entry in the attachments table 700. For example, the paralegal may prepare a draft of a letter to a client reporting an Office Action and, in a later stage of this workflow item, the working (or covering) attorney may augment or revise the letter and send it to the client. The contents of the IP assistant's local file (i.e., the draft reporting letter) are encoded as base-64 binary data, and this encoded data is stored in the attachments table 700. Base-64 encoding provides space-efficient storage; however, other data encoding schemes may be used or the file may be stored as unencoded data in the attachments table 700.

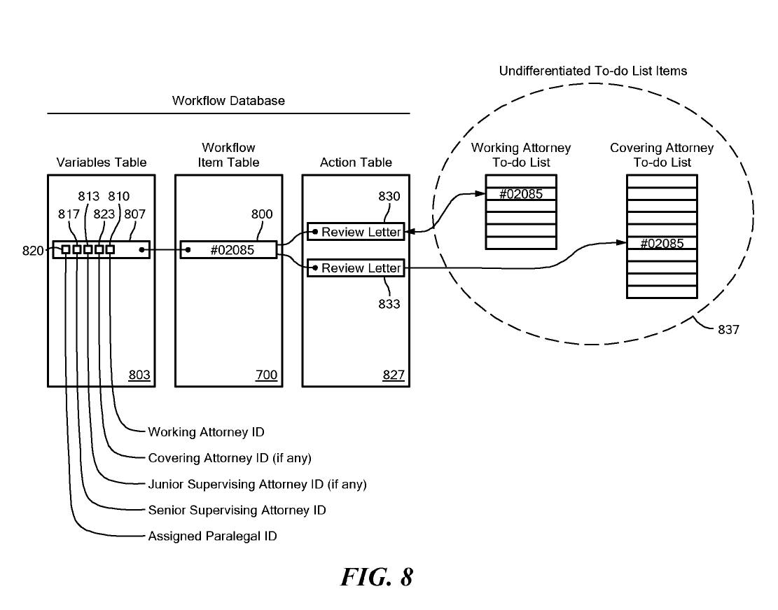

FIG. 8 is a schematic block diagram of additional tables that may be used to store information about workflow items, according to an embodiment of the present invention. For example, assume the workflow item just created by the IP assistant is workflow item #028085. A corresponding entry 800 is created in the workflow item table 700 by the utility used by the IP assistant. (The entry 800 may be created earlier by the workflow engine 157 in response to the eRaiseFlag request. However, for simplicity of explanation, we will refer to the utility as creating this and other entries.)

A variables table 803 contains entries that correspond to the entries in the workflow item table 700. An entry 807, also created by the utility, contains variables that correspond to the workflow item #028085 800. The variables in entry 807 may include an identifier 810 of the working attorney selected by the IP assistant, as described above with reference to FIG. 6. Similarly, the entry 807 may include identifiers of the junior 813 and senior 817 supervising attorney, as well as the assigned paralegal 820.

Although not displayed on the screen shown in FIG. 6, when the IP assistant selects a working attorney 610, the utility automatically queries the presence system 143 to ascertain if the selected working attorney is out of the office and a covering attorney has been designated. If an attorney has been designated to cover for the working attorney and the working attorney is out of the office, an identifier of the covering attorney 823 is also stored in the variables entry 807. Thus, if the working attorney is out of the office and a covering attorney has been designated, identities for both the working attorney and for the covering attorney are stored in the variables entry 807.

An action table 827 contains entries representing “to do” items. For example, the action to be performed to complete the next stage of the workflow item #02085 800 is to review a draft reporting letter. As noted, the stages of a workflow item are defined in the workflow definition 163. If two or more attorneys are assigned responsibility for a single workflow item (such as workflow item #02085 800), for example if one attorney is designated as a “working” attorney and another attorney is assigned to “cover” for the working attorney, an action table entry (such as entries 830 and 833) is created for each such attorney. Thus, the variables table entry 807 provides a capability for storing in a computer database information identifying a person (a “covering person”) who has a responsibility to complete the workflow item if the assigned person is unavailable to complete the workflow item. However, according to embodiments of the present invention, these two action table entries 830 and 833 can be distinguished by the variables entry 807. Thus, both the working attorney and the covering attorney appear to have “to do” items. Either attorney may complete “to do” item and allow the workflow item to progress on to its next stage, including completing the workflow item.

As noted, the presence datastore 143 is accessed to determine if the assigned person is available and to automatically identify the covering person. The capability for storing information identifying the covering person, i.e., the variables table entry 807, is used to automatically store information identifying the covering person.

### Attorney Console

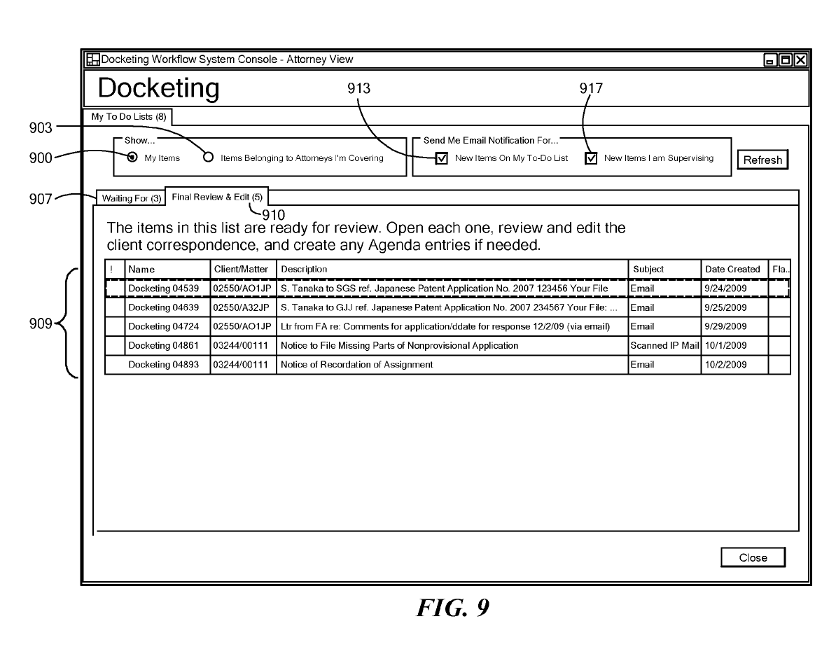

In accordance with embodiments of the present invention, the variables 810 and 823 enable the workflow system to distinguish between a working attorney and a covering attorney. FIG. 9 illustrates an attorney console user interface, according to an embodiment of the present invention. When an attorney launches the attorney console, the console program displays information specific to the attorney. The attorney console may use the attorney's log in information to identify the attorney and, therefore, display information from the systems and databases 100-170 (FIG. 1) that is specific to the attorney. (A paralegal console may be similarly constructed and used by a paralegal, as described herein.)

An attorney may view workflow items that are the attorney's responsibility separately from workflow items for which the attorney is merely covering. An attorney may command the console to display items that are the responsibility of the attorney, i.e., items for which the attorney is the working attorney, by selecting a “My Items” radio button 900. Alternatively, the attorney may command the console to display items that the attorney is covering by selecting an “Items Belonging to Attorneys I'm Covering” button 903. Depending on which radio button 900 or 903 is selected, the console selects action item table 827 (FIG. 8) entries, based on the contents of the corresponding variable entries 810 or 823, respectively. That is, if the “My Items” button 900 is active, the console displays action item table 827 entries that are associated with variable table 803 entries that contain the attorney's identification in the working attorney ID variable 810. On the other hand, if the covering button 903 is active, the console displays action item table 827 entries that are associated with variable table 803 entries that contain the attorney's identification in the covering attorney ID variable 823.

Some workflow items may be ready for the attorney's attention, and other workflow items may be at stages where others (such as paralegals) have responsibility for completing the current stages. If a workflow item is at a stage where another person must complete the stage, the workflow item is displayed under the tab labeled “Waiting For” 907. The number of such workflow items may be displayed on the tab 907. On the other hand, if the stage of the workflow item is such that the working attorney must act to complete the current stage, the workflow item is displayed under the tab labeled “Final Review & Edit” 910 or another tab “Initial Review” (not shown). Workflow items listed on the “Initial Review” tab may, for example, be newly received correspondence, which the working attorney is to briefly review and designate as urgent or not. Workflow items listed on the “Final Review & Edit” 910 tab may be, for example, draft reporting letters that have been prepared by paralegals and that should be reviewed and possibly edited before being sent to clients. In either case, either workflow items for which the user is listed as the working attorney or as the covering attorney are listed, depending on whether the “My Items” 900 or the covering items 903 control is selected. The selection of these two controls is mutually exclusive. Thus, the user sees either workflow items for which the user is the working attorney, or workflow items for which the user is the covering attorney, but not both. Alternatively, the working attorney and the covering attorney items may be simultaneously displayed in separate sub-windows (not shown) or otherwise segregated or identified.

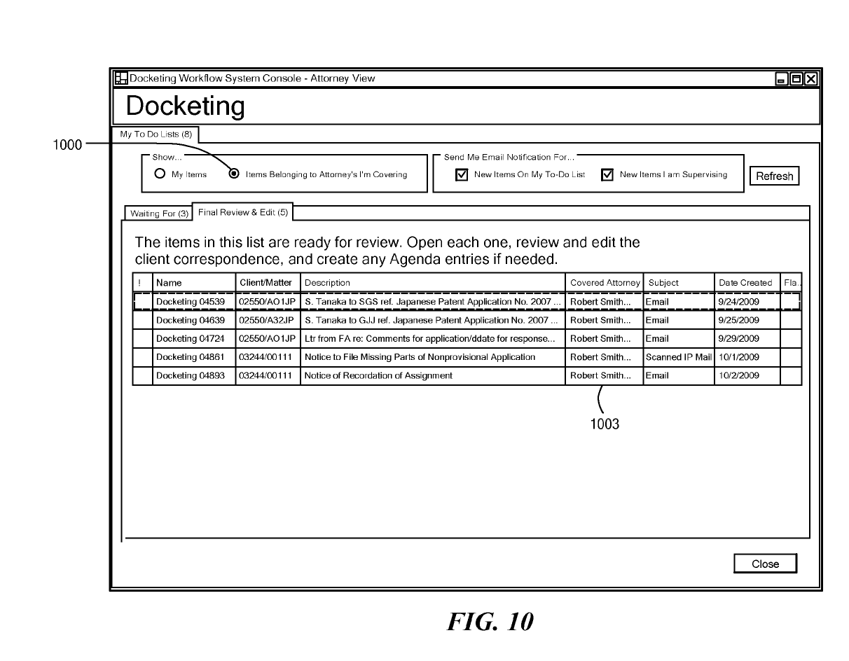

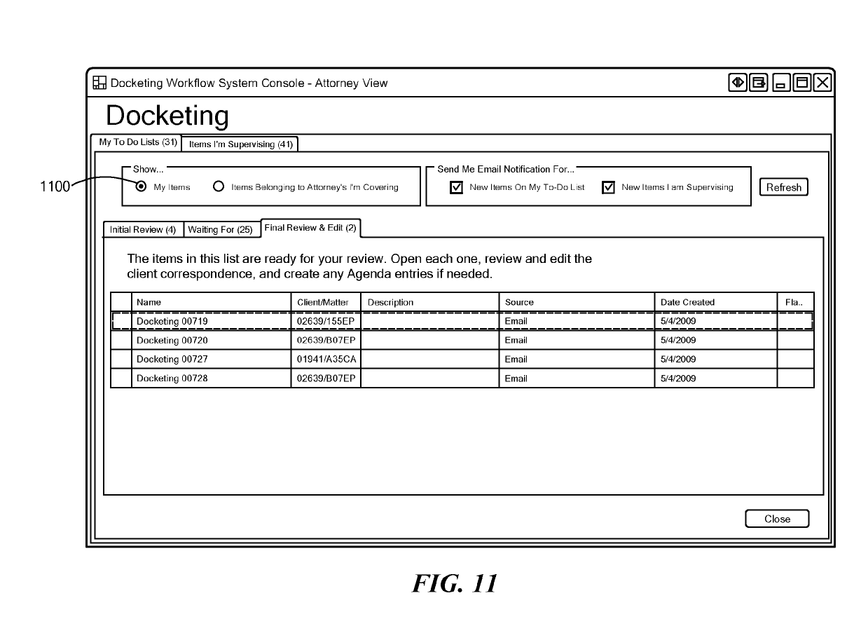

In the hypothetical attorney console display shown in FIG. 9, five workflow items are listed 909 on a working attorney's “Final Review & Edit” tab 910. If this working attorney is being covered by another attorney, and these workflow items were generated while the working attorney was out of the office and another attorney was designated to cover for the working attorney, these workflow items would also appear in the covering attorney's console display, as shown in FIG. 10, assuming the covering attorney selected the “Items Belonging to Attorneys I'm Covering” control 1000. As shown in FIG. 11, however, these workflow items do not appear in the covering attorney's console display if the “My Items” control 1100 is selected.

In some embodiments, a workflow item is associated with a covering attorney only when the workflow item is generated and only if the working attorney is out of the office and another attorney has been designated to cover the working attorney. In other embodiments, previously generated workflow items are dynamically associated with covering attorneys.

In one such embodiment, when a working attorney leaves the office or logs out and designates a covering attorney, the presence system 143 queries the workflow system 100 to identify workflow items that are the responsibility of the working attorney, but that do not already have covering attorneys associated with them. The presence system 143 then commands the workflow system 100 to associate the covering attorney, designated when the working attorney logged out, with the workflow items. When the working attorney returns to the office or logs on, the presence system 143 may command the workflow system 100 to modify the workflow items to disassociate them with the covering attorney.

In another such embodiment, the workflow system 100 periodically or occasionally queries the presence system 143 to ascertain the presence status of each working attorney that is associated with at least one workflow item in the workflow database 170. If the working attorney for any workflow item is found not to be in the office or logged out and having designated a covering attorney, the workflow system 100 automatically associates the designated covering attorney with the workflow item. Similarly, if the workflow system 100 ascertains that a previously absent working attorney is now in the office or logged in, the workflow system 100 automatically disassociates any covering attorneys from the now-present working attorney's workflow items.

### E-mail Notification of New Workflow Items

An attorney may wish to be notified by e-mail when a new workflow item is added to the attorney's workflow. The attorney console display (FIG. 9) includes check boxes 913 and 917, by which the attorney can command the workflow system 100 to send a notification e-mail message to the attorney when a new workflow item is added to the attorney's “to do” list or to the attorney's list of covered items, respectively. Recall from FIG. 3 that incoming correspondence precipitates the creation of new workflow items. Generally, after the initial review by an IP assistant, these new workflow items are queued to the respective working attorneys for initial reviews, during which the working attorneys may determine if the correspondence is urgent.

However, if the correspondence originally was sent directly to the working attorney or paralegal 327 (FIG. 3) as an e-mail message, and the working attorney or paralegal 327 forwarded the message to the docketing mailbox 317, there is no need for the working attorney to again review the correspondence to determine urgency, because that urgency determination was made when the original recipient 327 read the original message. Similarly, if the working attorney was included in the “cc” list of recipients of the original e-mail message, there is no need for the working attorney to again review the correspondence. Therefore, if a new workflow item has a source address (as discussed above, with respect to Table 2) of the working attorney or paralegal 327 for that workflow item, or the working attorney is included in the “cc” address, the initial review by the working attorney is bypassed, and no notification e-mail message is sent to the working attorney. This bypass may be implemented by appropriate configuration of the workflow definition 163. For example, if the “from” or “cc” address of the e-mail message contains a name that is selected by the IP assistant as the working attorney, the workflow definition 163 may include an indication that the workflow item should next be assigned to the next person in the workflow, thereby skipping the working attorney.

An e-mail message sent by the workflow system 100 to an attorney or paralegal to notify the attorney or paralegal of a new workflow item may include information about the workflow item, such as the project identification and a brief abstract (such as “Letter from foreign associate”). The e-mail message may also include a link to the workflow item, and the recipient may invoke the link to cause a window to open and display the contents of the workflow item. FIG. 12 illustrates an exemplary display of a workflow item.

The display includes a list 1200 of documents associated with the workflow item. Recall that the IP assistant may have associated one or more documents with the workflow item and/or one or more documents may have been automatically associated with the workflow item. In addition, other users along a workflow may associate additional documents with a workflow item. As discussed with respect to FIG. 7, links to documents stored in the document management system 110 may be stored in an attachments table 703, and other (non-document management system) documents associated with the workflow item may be stored as base-64 encoded binary data within the attachments table 703.

The recipient may select one of the documents in the list 1200 and invoke an “Open Selected” button 1203 to open the selected document. The workflow system 100 creates a temporary file from the contents of the attachment table entry and opens the temporary file. Because document types (including links to documents stored in the document management system 110) and corresponding viewing application programs are typically registered with an operating system, when the workflow system 100 opens the temporary file, the operating system launches an appropriate viewing application program.

Although uniform resource locators (URLs) may be used to identify workflow items, invoking such a URL may cause undesirable portions of a user interface, such as toolbars, to be displayed. These undesirable user interface elements are more appropriate to software developers than to law firm end-users.

We have discovered that an appropriately configured Java script may be used to hide the toolbars and other undesirable user interface elements. However, Microsoft Outlook prevents execution of Java scripts when displaying e-mail messages. We devised a new type of resource locator we call a “BPM (business process management) Resource Link” or “BRL” to overcome this limitation. A BRL is a small text file that identifies a workflow item, i.e., the BRL contains the workflow item number or other identifier that is meaningful to the workflow engine 157. The file's file type, as well as an associated agent, is registered with an operating system. Thus, when a BRL is invoked, the operating system launches the agent to process the BRL.

An e-mail message that notifies a user of a new workflow item includes a BRL that identifies the workflow item. When the recipient invokes (such as by double-clicking) the BRL within the e-mail message, the agent executes a Java script, which opens a browser window (such as an Internet Explorer browser window) to display the contents of the workflow item, without the undesirable user interface elements. In one embodiment, the agent issues a window.open method, passing the URL of the workflow item and well-known parameters that cause the workflow engine 157 to hide the undesirable user interface elements.

### Paralegal Processing of a Workflow Item

As noted, an IP assistant reviews and profiles incoming correspondence and enters information about a corresponding new workflow item, such as its project identification and assigned paralegal. In addition, the IP assistant associates documents with the workflow item. Continuing the example of a workflow item related to docketable incoming correspondence, a paralegal may then docket the correspondence (such as a due date for responding to an Office Action) and draft a reporting letter to the client and attach the draft reporting letter to the workflow item.

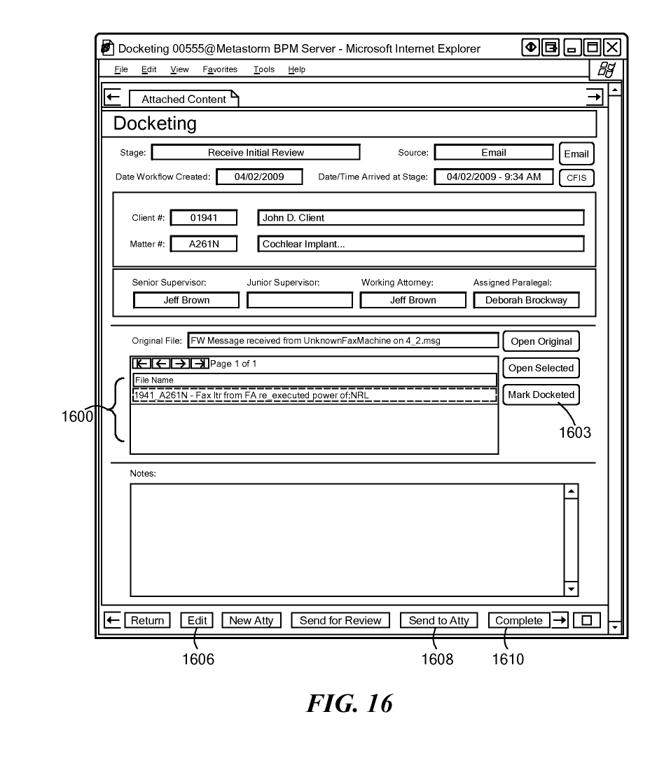

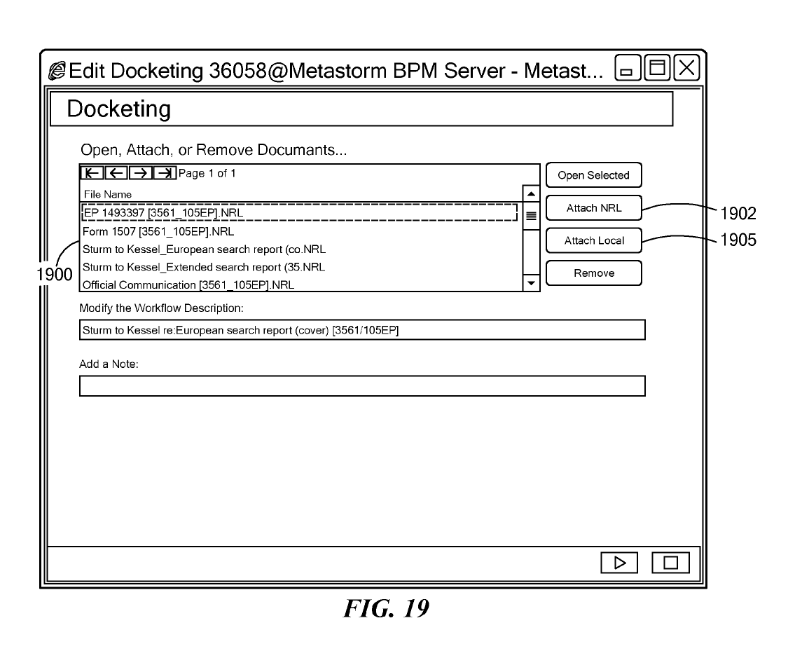

FIG. 16 is an exemplary display provided by the workflow engine 157 to the paralegal to facilitate his completion of a stage in this workflow. If, for example, the paralegal drafts a reporting letter using a word processor and stores the reporting letter document in the document management system 110 or locally on the paralegal's computer, the paralegal may then invoke an “Edit” control 1606 to edit the corresponding workflow item. Invoking the control 1606 causes display of an edit dialog box, exemplified in FIG. 19. Here, documents attached to this workflow item are displayed in a window 1900, and the paralegal may invoke an “Attach NRL” control 1902 to attach additional documents from the document management system 110. Invoking the control 1902 causes display of a chooser window (not shown), by which one or more documents from the document management system 110 may be selected. Links to the selected documents are stored in association with the newly created workflow item. Similarly, the dialog box of FIG. 19 includes an “Attach Local” control 1905 for attaching documents that are stored locally on the paralegal's computer or accessible via a computer network by the paralegal's computer. Invoking the control 1905 causes display of a chooser window (not shown), by which one or more local documents may be selected. Selected documents are encoded and stored in the workflow item, as previously discussed.

Once the paralegal completes his stage of the workflow, the paralegal invokes a “Send to Atty” control 1608 (FIG. 16), and the workflow engine 157 modifies the workflow item 343 to change the stage of the workflow item 343 to indicate it is now the responsibility of the working attorney. On the other hand, if the paralegal can complete the workflow item, i.e., no action is required by the working attorney or any other person, the paralegal may invoke a “Complete” control 1610.

### Generating E-Mail Messages from Workflow Items

Once the paralegal completes her stage of the workflow and invokes the “send to Atty” control 1608 (FIG. 16), the workflow item is ready for the working attorney. The working attorney or the covering attorney opens the correspondence in its corresponding word processor application program. The attorney can edit and add to the draft reporting letter.

The attorney workflow item display shown in FIG. 12 may be used by the working attorney to open (and possibly edit) the documents 1200 associated with the workflow item. In addition, the console includes a “CFIS” button 1207 that invokes the case document and information integration system 153, so the working attorney may easily obtain additional information and view relevant documents related to the workflow item.

However, not all workflow items may be handled by all working attorneys in the same way. For example, in some cases, the working attorney may wish to consult with a paralegal or with another attorney, before completing a reporting letter. As part of this consultation, the working attorney may wish to provide one of the documents associated with the workflow item to the paralegal or to the other attorney.

Similarly, some working attorneys may wish to send completed reporting letters via e-mail, while other working attorneys may wish to have their assistants send the reporting letters via postal mail or upload scanned copies thereof to a client's electronic patent management system portal. Clients may also have instructed working attorneys on ways they wish to receive reporting letters. Thus, once the reporting letter is complete, the working attorney may send the letter, and “cc” and “bcc” copies thereof, to the client and to other parties via a combination of e-mail, postal mail, fax, etc.

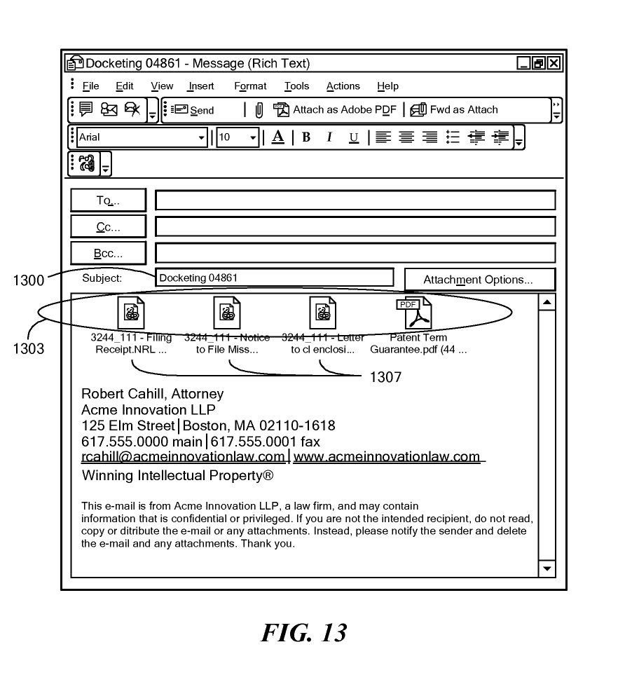

To provide the working attorney with flexibility in the way he consults with others in the law firm and in the way he sends the reporting correspondence, the attorney console includes an “Email” button 1210. Activating the Email button 1210 causes the console to generate an e-mail message from the user. The e-mail message has attached to it links to all the documents that are associated with the workflow item. An example of such an e-mail message is shown in FIG. 13. The subject line of the e-mail message 1300 is automatically populated with the workflow item identifier, and the documents 1303 are automatically attached in the body of the e-mail message. The working attorney may delete any of the attachments and/or alter the subject line, attach additional documents, add text to the body of the e-mail message and address the e-mail message to whomever the working attorney wishes, although typically such messages are sent only to others within the law firm. It should be noted that links to documents stored in the document management system 110 (such as links 1307) are typically meaningful only within the law firm's computer network (possibly including any virtual private LAN).

To attach the documents 1303 to the e-mail message, the console creates a temporary file for each of the documents associated with the workflow item. Recall that some of the associated documents are stored in the attachments table 703 (FIG. 7) while other documents, such as documents stored in the document such as management system 110, are represented by links store in the attachments table 703. A script decodes these documents or links before generating the temporary files or links, and then the console attaches the temporary files to the generated e-mail message. The script may then delete the temporary files.

Once the working attorney is satisfied with the e-mail message, she may send the message. For example, if the working attorney wishes to consult with a colleague, the working attorney may leave the relevant documents attached to the e-mail message and pose a question or propose a meeting in the body of the e-mail message. On the other hand, if the reporting letter is complete and the working attorney wishes to have her assistant print and mail the reporting letter, the working attorney may leave the link to the reporting letter attached to the e-mail message and, in the body of the e-mail message, instruct the assistant to print the letter, bring it to the working attorney for signature and then mail or fax the reporting letter.

### Generating E-mail Message from a Word Processor

As noted, as part of a workflow, a paralegal may draft a reporting letter for a working attorney, and the working attorney may then augment and send the letter to a client. When the paralegal drafts the letter, the paralegal may include boilerplate text, such as a generic description of an Office Action, as well as project-specific information, such as a due date for responding to the particular Office Action that precipitated generation of the corresponding workflow item. Once the paralegal completes her stage of the workflow item, i.e., she drafts the reporting letter, the working attorney may edit and add to the letter, as discussed above. When the working attorney sends the completed reporting letter to the client, the working attorney may enclose or attach other documents, such as a copy of the Office Action, prior art references or a boilerplate document that describes patent term guarantees and their requirements.

To facilitate including or attaching the relevant documents to the reporting letter and to facilitate addressing the reporting letter, the paralegal may use a utility to store information identifying the workflow item along with the reporting letter. In one embodiment, the utility used by the paralegal is implemented as a Visual Basic for Applications (VBA) program, which stores the workflow item identification in a Microsoft Word document variable. Thus, this information is stored as metadata along with the document; however, the information is not visible when the document is displayed by the word processor, nor is the information printed when the document is sent to a printer. Code Fragment 1 contains exemplary code for storing a workflow item identification in a document variable.

Code Fragment 1

Dim WFID As String
WFID = “02085”
ActiveDocument.CustomDocumentProperties.Add
Name:=“WorkFlowItemID”, Type:=msoPropertyTypeString,
Value:=WFID

If the reporting letter may be sent via e-mail, the paralegal may also store a subject line and “to,” “cc” and “bcc” address information for the reporting letter in other document variables. The paralegal may obtain this information from the case document and information integration system 153, from the original correspondence or from a variety of sources.

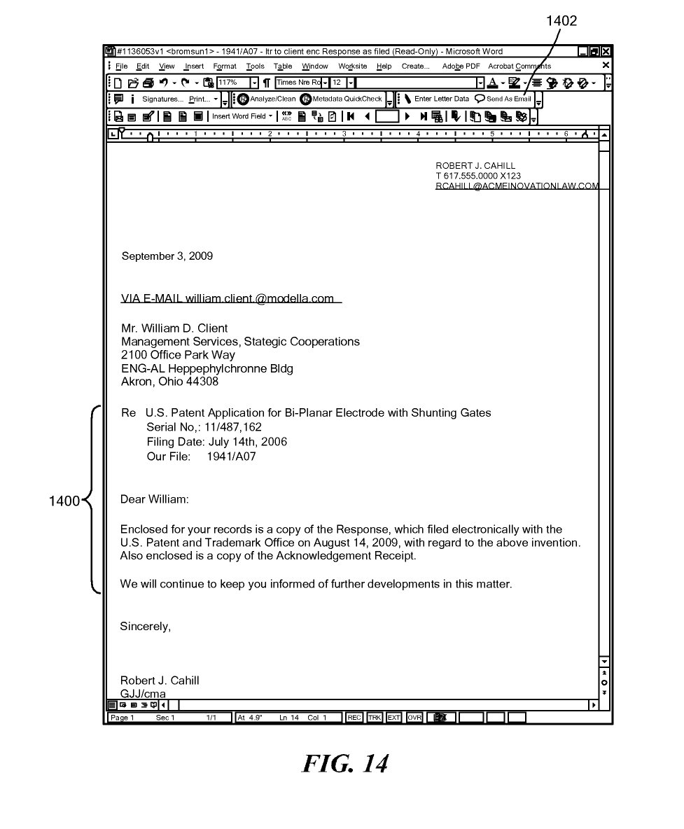

After the working attorney has opened and edited the draft reporting letter and the letter is ready to be sent, the working attorney may wish to send the reporting letter as an e-mail message. If so, the working attorney may invoke another utility that uses the document variables set up by the paralegal to automatically generate the e-mail message. The working attorney selects a portion 1400 of the reporting letter that is to be sent in the body of the e-mail message using a conventional word processor selection mechanism (ex., click and drag) and then invokes a “Send as Email” button 1402 on a word processor toolbar, as illustrated in FIG. 14.

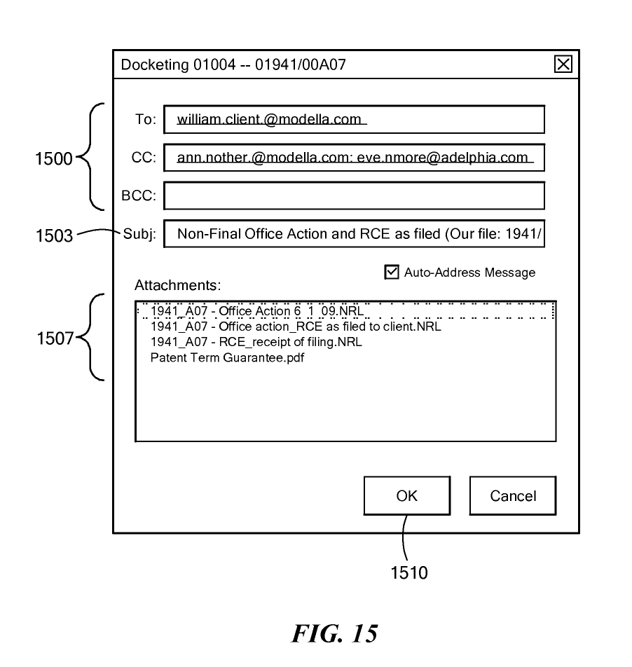

The button 1402 causes the utility, which may also be implemented as a VBA program, to be executed. The utility pastes the selected portion 1400 of the reporting letter into the generated e-mail message. The utility uses the document variable that stores the corresponding workflow item identifier to open the workflow item and obtain information about it, such as the list of documents associated with the workflow item. The utility then displays a user interface, as exemplified in FIG. 15, to display to the working attorney the address information 1500 and subject line 1503 previously set up by the paralegal. The user interface also lists the documents 1507 associated with the workflow item.

The working attorney may then edit the address fields 1500 and the subject line 1503. The working attorney may also select zero or more of the documents 1507 for attachment to the e-mail message. Typically, the working attorney selects one or more documents, such as a copy of an Office Action and related prior art references, for attachment. However, the working attorney typically does not include the word processing document (as opposed to an image of a document, such as a PDF document) that is the reporting letter, because the selected text will be included in the body of the e-mail message. Thus, the word processing document would be redundant. Optionally, if any word processing document is selected in the list 1507, the utility warns the working attorney and asks for confirmation that the word processing document should be attached.

Once the working attorney invokes the “OK” button 1510, the utility generates an e-mail message addressed from the working attorney. The subject line and the “to,” “cc” and “bcc” address fields of the e-mail message are populated from the (possibly edited) fields 1500 and 1503.

The utility copies the selected text from the word processing document into a temporary file in preparation for copying the text into the body of the e-mail message. In some embodiments, the text is saved in HTML format to preserve its formatting. However, this HTML may include declared objects that make use of registered class identifiers. An example of such an object is shown in Code Fragment 2. Such objects may prevent proper rendering of the text by the recipient's mail client. These declared objects are deleted.

Code Fragment 2

<!--[if !mso]>
<object classid=“clsid:38481807-CA0E-42D2-BF39-B33AF135CC4D”
id=ieooui>
</object>
<style>
st1\:*{behavior:url(#ieooui) }
</style>
<![endif]-->

In addition, the documents selected in the list 1507 are attached to the e-mail message. For each such selected document that is represented by a link to a document in the document management system 110, the utility exports a copy of the document from the document management system 110 as a temporary file, and then the utility attaches the temporary file to the e-mail message. The working attorney may then edit the e-mail message body and/or attach additional documents and finally send the e-mail message.

Optionally, the working attorney may include outdocketing 337 (FIG. 3) as a “cc” or “bcc” recipient of the e-mail message. As noted, doing so will cause another workflow item to be generated, which will eventually cause a copy of the outgoing reporting letter to be docketed and/or stored in the document management system 110. Such an outgoing workflow item can be completed by a paralegal once the letter has been docketed.

The utility may add text to the word processing document to indicate that its contents have been sent via e-mail. For example, the utility may add a line of text similar to “E-mail prepared from this document by <working attorney> on Nov. 6, 2009 4:11:12 PM” to the beginning of the word processing document. The working attorney may then close the word processing document.

As noted, reporting letters and other correspondence to clients, patent offices, foreign associates, etc. may be sent via a variety of modes, such postal mail, e-mail, fax, courier, etc. If the working attorney chooses to send the reporting letter via postal mail or another mode (other than via e-mail), the working attorney would not invoke the “Send as Email” button 1402. Instead, the working attorney may edit the reporting letter as described above, then close the word processing document and use the “Email” button 1210 (FIG. 12) to send a link to the document, along with instructions, to the working attorney's assistant to print the document in preparation for signing and sending it to the client.

### Electronic Document Stamping

Typically, once a paralegal has entered due dates related to a physical piece of correspondence, the paralegal marks the physical correspondence, such as with a “Docketed” stamp. According to some embodiments of the present invention, physical correspondence may be discarded after it has been processed as described herein or the correspondence may not have a physical counterpart. However, to record the fact that a piece of correspondence has been docketed, additional metadata may be stored with the profiled copy of the correspondence, i.e., along with the copy of the correspondence as it is stored in the document management system 110.

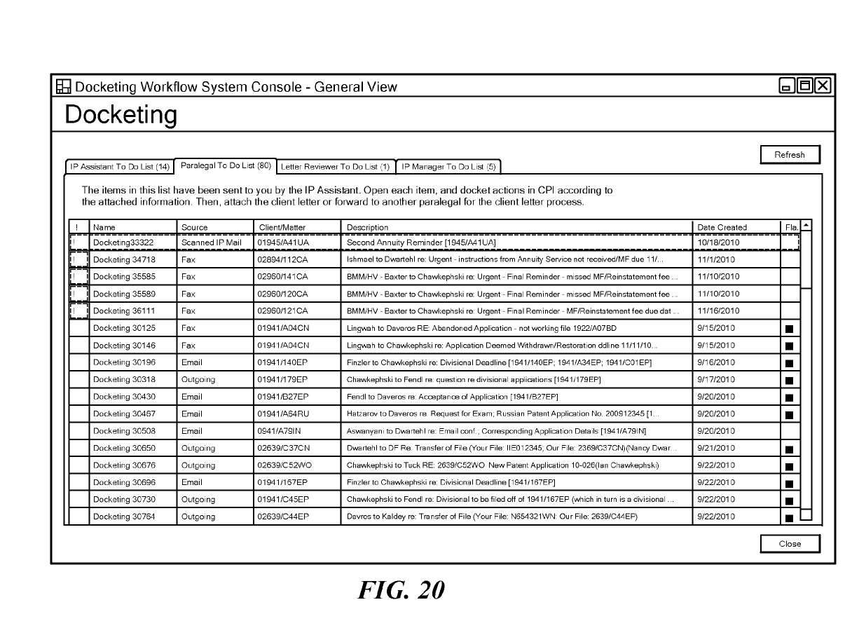

According to an embodiment of the present invention, a paralegal console, somewhat similar to the working attorney console described above with respect to FIGS. 9-11, is provided. A paralegal console display, exemplified in FIG. 20, similar to the working attorney console display shown in FIG. 9 displays workflow items to which the paralegal is assigned. A paralegal display exemplified in FIG. 16 shows information about a single workflow item. The display shown in FIG. 16 is similar to the working attorney display of FIG. 12. For example, the display includes a list 1600 of documents associated with the workflow item. The paralegal may electronically mark one of these documents by selecting it in the list 1600 and invoking a “Mark Docketed” button 1603. Recall that the workflow item attachments table 703 (FIG. 7) contains documents and/or links to documents associated with the workflow item. In response to the paralegal invoking the button 1603, a script console obtains a link to the selected document and accesses the document or the document properties in the document management system 110. The script stores metadata in the document management system 110 to indicate the selected document has been docketed. In some embodiments, the script stores a document variable in the document. In other embodiments, the script stores metadata in a predefined or custom field, as provided by the document management system 110.

### IP Manager Console

In addition to the working attorney console and the assigned paralegal console described above, some embodiments of the present invention also include an IP manager console. The IP manager may use displays (not shown) provided by the IP manager console to view the status of workflow items. In addition, the IP manager may reassign workflow items among the available paralegals. A script changes values stored in the variables table 803, such as the assigned paralegal ID 820, to reflect the change in assigned paralegal.

### “Purgatory”; Purging Workflow Item Comments

Throughout the workflow, users may add comments to workflow items. For example, the IP assistant may add comments in an “Add a Note” field 637 (FIG. 6). The displays provided for the attorney, the assigned paralegal and the IP manager have similar comment fields. Comments added by users of the system may be cumulative.

When a workflow item is determined by the workflow disposer to be spurious, the workflow item may be stored for a period of time (such as 30 days) before it is ultimately archived and/or deleted. Delaying the ultimate disposal of the workflow item enables reactivating the workflow item or reviewing it, if necessary. Once the designated delay period has lapsed, any comments in a workflow item may be deleted, before the workflow item is archived.

Similarly, once all stages of a workflow item have been completed, the workflow item may be stored for a period of time, and then the comments may be deleted and the workflow item may be archived and/or deleted.

In accordance with an exemplary embodiment, a workflow system and related methods are provided. The workflow system, consoles, utilities and other components of the above described embodiments may include or be implemented by a processor controlled by instructions stored in a memory. The memory may be random access memory (RAM), read-only memory (ROM), flash memory or any other memory, or combination thereof, suitable for storing control software or other instructions and data. Some of the functions performed by the workflow system, consoles, utilities and other components have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of the illustrated embodiments may be made without departing from the inventive concepts disclosed herein. For example, although some aspects of the workflow system, consoles, utilities and other components have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiment(s).

What is claimed is:

1. A computer-implemented method for storing information about at least one workflow item, for each such workflow item the method comprising:
storing, in a computer database in association with information about the workflow item, information identifying a person (an “assigned person”) who has a responsibility to complete the workflow item; and
providing, in association with the information about the workflow item, a capability for storing in the computer database information identifying a person (a “covering person”) who has a responsibility to complete the workflow item if the assigned person is unavailable to complete the workflow item.

2. A method according to claim 1, further comprising:
accessing a presence datastore to determine if the assigned person is available;
using the presence datastore to automatically identify the covering person; and
using the capability for storing information identifying the covering person to automatically store information identifying the covering person.

3. A method according to claim 2, wherein:
using the presence datastore to automatically identify the covering person comprises using the presence datastore to automatically identify the covering person based on a classification of the workflow item.

4. A computer-implemented method for generating workflow items, the method comprising:
automatically checking for delivery of an e-mail message to at least one predetermined e-mail address; and
automatically creating a workflow item based at least in part on a source address of an e-mail message delivered to the at least one predetermined e-mail address.

5. A method according to claim 4, wherein automatically creating the workflow item based at least in part on the source address comprises automatically creating the workflow item based at least in part on a rule base that identifies which portion of the delivered e-mail message is to be used, based on the source address of the e-mail message.

6. A method according to claim 5, wherein the rule base identifies which portion of the delivered e-mail message is to be used at least in part by distinguishing between an attachment to the delivered e-mail message and a body of the delivered e-mail message.

7. A method according to claim 4, wherein the source address comprises an identification selected from a group consisting of: an identification associated with a scanner, and identification associated with an incoming fax server and an identification associated with a human user.

8. A method according to claim 4, further comprising automatically downloading at least one document over the Internet in response to delivery of the e-mail message delivered to the at least one predetermined e-mail address.

9. A method according to claim 8, wherein downloading the at least one document over the Internet comprises downloading at least an Office Action from a patent office.

10. A computer-implemented method for generating an e-mail message, the method comprising:
displaying information about a workflow item, the workflow item having at least one document associated therewith;
in response to an input from a user, generating an e-mail message and automatically attaching to the e-mail message at least one of the at least one document associated with the workflow item.

11. A method according to claim 10, wherein automatically attaching the at least one of the at least one document associated with the workflow item to the e-mail message comprises automatically attaching all of the at least one document associated with the workflow item.

12. A method according to claim 10, wherein, for at least one of the at least one document associated with the workflow item, automatically attaching the document to the e-mail message comprises:
automatically obtaining a copy of the document from a document management system; and
automatically attaching the copy of the document to the e-mail message.

13. A computer-implemented method for associating a document with a workflow item, the method comprising:
using a word processor to display a document;
receiving from a user of the word processor an indication of a workflow item; and
automatically storing metadata in association with the document, the metadata including information identifying the indicated workflow item.

14. A method according to claim 13, wherein storing the metadata comprises storing the information in a document variable.

15. A method according to claim 13, further comprising:
automatically ascertaining a project identification associated with the workflow item;
automatically obtaining contact information associated with the project identification; and
storing the contact information in the document.

16. A method according to claim 15, wherein the automatically obtaining the contact information comprises using the project identification to query a client information database.

17. A method according to claim 15, further comprising:
automatically storing the project identification in the document.

18. A method according to claim 17, wherein automatically storing the project identification comprises storing the project identification in a document variable.

19. A computer-implemented method for generating an e-mail message based on text selected in a document, the method comprising:
using a word processor to display a document that includes information identifying a workflow item;
receiving an indication of a portion of the displayed document selected by the user; and
in response to an input from the user:
generating an e-mail message; and
automatically copying the portion of the displayed document selected by the user into the e-mail message.

20. A method according to claim 19, the method further comprising automatically addressing the e-mail message.

21. A method according to claim 20, wherein:
the document further includes contact information stored as metadata; and
automatically addressing the e-mail message comprises addressing the e-mail message according to the contact information.

22. A method according to claim 20, wherein automatically addressing the e-mail message comprises using the information identifying the workflow item to automatically ascertain contact information.

23. A method according to claim 20, wherein automatically addressing the e-mail message comprises:
using the information identifying the workflow item to automatically ascertain a project identification; and
using the project identification to automatically query a client information database for contact information.

24. A method according to claim 20, wherein:
at least one other document is associated with the workflow item; the method further comprising:
displaying a user interface listing the at least one other document associated with the workflow item and by which the user can select at least one of the listed at least one other document; and
attaching a user-selected at least one of the listed at least one other document to the e-mail message.

25. A method according to claim 24, wherein, for at least one of the selected at least one of the listed document, attaching the document to the e-mail message comprises:
automatically obtaining a copy of the document from a document management system; and
automatically attaching the copy of the document to the e-mail message.

26. A computer program product for providing storing information about at least one workflow item, the computer program product comprising a non-transitory computer-readable medium having computer readable program code thereon, the computer readable program including:
program code configured to store, in a computer database in association with information about the workflow item, for each such workflow item, information identifying a person (an “assigned person”) who has a responsibility to complete the workflow item; and;
program code configured to provide, in association with the information about the workflow item, a capability for storing in the computer database information identifying a person (a “covering person”) who has a responsibility to complete the workflow item if the assigned person is unavailable to complete the workflow item.

27. A system for storing information about at least one workflow item, the system comprising:
a computer database configured to store:
in association with information about the workflow item, for each such workflow item, information identifying a person (an “assigned person”) who has a responsibility to complete the workflow item; and
in association with the information about the workflow item, information identifying a person (a “covering person”) who has a responsibility to complete the workflow item if the assigned person is unavailable to complete the workflow item.

28. A computer program product for generating an e-mail message, the computer program product comprising a non-transitory computer-readable medium having computer readable program code thereon, the computer readable program including:
program code configured to display information about a workflow item, the workflow item having at least one document associated therewith; and
program code configured to, in response to an input from a user, generate an e-mail message and automatically attaching to the e-mail message at least one of the at least one document associated with the workflow item.

29. A system for generating an e-mail message, comprising:
a computer configured to display information about a workflow item, the workflow item having at least one document associated therewith; and
a computer configured to, in response to an input from a user, generate an e-mail message and automatically attach to the e-mail message at least one of the at least one document associated with the workflow item.

30. A computer program product for associating a document with a workflow item, the computer program product comprising a non-transitory computer-readable medium having computer readable program code thereon, the computer readable program including:
program code configured to use a word processor to display a document;
program code configured to receive from a user of the word processor an indication of a workflow item; and
program code configured to automatically store metadata in association with the document, the metadata including information identifying the indicated workflow item.

31. A system for associating a document with a workflow item, comprising:
a word processor configured to display a document;
a user interface configured to receive from a user of the word processor an indication of a workflow item; and
a computer program configured to automatically store metadata in association with the document, the metadata including information identifying the indicated workflow item.
